(19) United States
(12) Patent Application Publication
(10) Pub. No.: US 2015/0319685 A1
(43) Pub. Date: Nov. 5, 2015

(54) TECHNIQUES FOR MANAGING WIRELESS COMMUNICATIONS USING A DISTRIBUTED WIRELESS LOCAL AREA NETWORK DRIVER MODEL

(71) Applicant: QUALCOMM Incorporated, San Diego, CA (US)

(72) Inventors: Suli Zhao, San Diego, CA (US); Sivaramakrishna Veerepalli, San Diego, CA (US); Dagbegnon Henri Bahini, San Diego, CA (US); Umang Sureshbhai Patel, Santa Clara, CA (US); Arnaud Meylan, San Diego, CA (US)

(21) Appl. No.: 14/547,637

(22) Filed: Nov. 19, 2014

Related U.S. Application Data
(60) Provisional application No. 61/988,142, filed on May 2, 2014.

(51) Int. Cl. H04W 48/20; H04W 88/02; H04W 84/12; H04W 40/02; H04W 8/10

(52) U.S. Cl. CPC H04W 48/20; H04W 40/02; H04W 8/10; H04W 84/12; H04W 88/02

(57) ABSTRACT

Systems, methods, apparatus, and devices for wireless communication are described. A first method includes establishing a first wireless local area network (WLAN) interface between a WLAN chipset and an application processor (AP) subsystem, and establishing a second WLAN interface between the WLAN chipset and a modem subsystem. The second WLAN interface may include a data path between the WLAN chipset and the modem subsystem. The data path may bypass the AP subsystem. A second method includes establishing a WLAN interface between a WLAN chipset and AP subsystem, and dynamically managing WLAN connectivity through the WLAN interface using a modem subsystem.

### CROSS REFERENCES

The present application for patent claims priority to U.S. Provisional Patent Application No. 61/988,142 by Zhao et al., entitled “Techniques for Managing Wireless Communications Using a Distributed Wireless Local Area Network Driver Model,” filed May 2, 2014, and assigned to the assignee hereof.

### BACKGROUND

The following relates generally to wireless communications, and more specifically to the management of data connectivity at a user equipment (UE) operating within a wireless communication system. Wireless communication systems are widely deployed to provide various types of communication content such as voice, video, packet data, messaging, broadcast, and so on. These systems may be multiple-access systems capable of supporting communication with multiple users by sharing the available system resources (e.g., time, frequency, and power). Examples of such multiple-access systems include code-division multiple access (CDMA) systems, time-division multiple access (TDMA) systems, frequency-division multiple access (FDMA) systems, and orthogonal frequency-division multiple access (OFDMA) systems.

Generally, a wireless multiple-access communication system may include a number of access points, each simultaneously supporting communication for multiple UEs. Different access points may in some cases be associated with different access networks, including Wireless Wide Area Network (WWAN) access networks or Wireless Local Area Network (WLAN) access networks. In some cases, it may be desirable to coordinate or integrate the transmission or reception of data packets over different WLAN access networks, or over a WWAN access network and a WLAN access network.

### SUMMARY

The described features generally relate to improved systems, methods, apparatuses, and devices for wireless communication that may enable a device such as UE to integrate the transmission or reception of data packets over different WLAN access networks, or over a WWAN access network and a WLAN access network.

In a first set of illustrative examples, a method for wireless communication is described. In one configuration, the method includes establishing a first wireless local area network (WLAN) interface between a WLAN chipset and an application processor (AP) subsystem, and establishing a second WLAN interface between the WLAN chipset and a modem subsystem. The second WLAN interface may include a data path between the WLAN chipset and the modem subsystem. The data path may bypass the AP subsystem.

In some embodiments, the method may include transitioning the application processor subsystem to a power saving mode when WLAN traffic associated with the application processor subsystem is absent.

In some configurations, the data path between the WLAN chipset and the modem subsystem may include a direct digital interconnect. The direct digital interconnect may implement a peripheral component interconnect express (PCIe) interface.

In some examples, the method may include routing, via at least one filter, data packets received by the WLAN chipset to the application processor subsystem or the modem subsystem. The at least one filter may be specified by the application processor subsystem or the modem subsystem. When a filter is specified by the modem subsystem, the filter may be provided to the WLAN chipset by the modem subsystem, via a control interface connecting the WLAN chipset and the modem subsystem. Alternatively, the filter may be provided to the application processor subsystem by the modem subsystem, and to the WLAN chipset by the application processor subsystem. The filters may be installed, for example, in the WLAN chipset or in the data path between the WLAN chipset and the modem subsystem.

In a second set of illustrative examples, a device for wireless communication is described. In one configuration, the device may include a WLAN chipset, an application processor subsystem, a modem subsystem, and a wireless communication manager. The wireless communication manager may establish a first WLAN interface between the WLAN chipset and the application processor subsystem, and establish a second WLAN interface between the WLAN chipset and the modem subsystem. The second WLAN interface may include a data path between the WLAN chipset and the modem subsystem. The data path may bypass the application processor subsystem. In some examples, the device may include further components or configurations for implementing at least one aspect of the method for wireless communication described above with respect to the first set of illustrative examples.

In a third set of illustrative examples, another device for wireless communication is described. In one configuration, the device may include means for establishing a first WLAN interface between a WLAN chipset and an application processor subsystem, and means for establishing a second WLAN interface between the WLAN chipset and a modem subsystem. The second WLAN interface may include a data path between the WLAN chipset and the modem subsystem. The data path may bypass the application processor subsystem. In some examples, the device may further include means for implementing at least one aspect of the method for wireless communication described above with respect to the first set of illustrative examples.

In a fourth set of illustrative examples, a computer program product for communication by a wireless communication device in a wireless communication system is described. The computer program product may include a non-transitory computer-readable medium storing instructions executable by a processor to cause the wireless communication device to establish a first WLAN interface between a WLAN chipset and an application processor subsystem, and establish a second WLAN interface between the WLAN chipset and a modem subsystem. The second WLAN interface may include a data path between the WLAN chipset and the modem subsystem. The data path may bypass the application processor subsystem. In some examples, the apparatus may further include means for implementing at least one aspect of the method for wireless communication described above with respect to the first set of illustrative examples.

In a fifth set of illustrative examples, another method for wireless communication is described. In one configuration, the method includes establishing a WLAN interface between a WLAN chipset and AP subsystem, and dynamically managing WLAN connectivity through the WLAN interface using a modem subsystem.

In some embodiments, the method may include establishing the WLAN interface using a WLAN station. In these embodiments, the method may also include configuring the WLAN station to operate in one of a first mode in which the WLAN station is enabled to associate only with a high level operating system (HLOS) service set identifier (SSID), a second mode in which the WLAN station is enabled to associate only with a modem SSID, and a third mode in which the WLAN station is enabled to associate with one of a HLOS SSID and a modem SSID based on a HLOS/modem SSID prioritization.

In some cases, at least one modem SSID may be transferred from the modem subsystem to a WLAN driver of the application processor subsystem, the WLAN station may operate in the third mode, and a modem SSID may be prioritized with respect to a HLOS SSID. The WLAN station may then be associated with the modem SSID or the HLOS SSID based on the prioritizing.

In some embodiments, the method may include associating the WLAN station with a modem SSID. In these embodiments, dynamically managing the WLAN connectivity through the WLAN interface using the modem subsystem may include the modem subsystem dynamically managing, through a WLAN driver of the application processor subsystem, WLAN connectivity on the WLAN station. The WLAN driver of the application processor subsystem may hide a WLAN connection that uses the WLAN station from the HLOS. Also or alternatively, the HLOS may relinquish management of the WLAN station to the modem subsystem for a period of time. When the association of the WLAN station with the modem SSID terminates, management of the WLAN connectivity on the WLAN station by the modem subsystem may be relinquished.

In some embodiments, the method may include establishing the WLAN interface using at least one of a first WLAN station and a second WLAN station. In some cases, at least one of the first WLAN station and the second WLAN station may be enabled.

In some examples, the first WLAN station may be associated with a HLOS SSID via a WLAN driver of the application processor subsystem. In the same or other examples, the method may include configuring the second WLAN station to operate in one of a first mode in which the second WLAN station is enabled to associate only with a HLOS SSID, a second mode in which the second WLAN station is enabled to associate only with a modem SSID, and a third mode in which the second WLAN station is enabled to associate with one of a HLOS SSID and a modem SSID based on a HLOS/modem SSID prioritization.

In some configurations, the method may include associating, under control of the modem subsystem, the second WLAN station with a modem SSID. In these configurations, dynamically managing the WLAN connectivity through the WLAN interface using the modem subsystem may include the modem subsystem dynamically managing, through a WLAN driver of the application processor subsystem, WLAN connectivity on the second WLAN station.

In some examples, the method may include the WLAN driver of the application processor subsystem hiding a WLAN connection that uses the second WLAN station from the HLOS, or the HLOS relinquishing management of the second WLAN station to the modem subsystem for a period of time. When the association of the second WLAN station with the modem SSID terminates, the modem subsystem may relinquish management of the WLAN connectivity on the second WLAN station.

In a sixth set of illustrative examples, another device for wireless communication is described. In one configuration, the device may include a WLAN chipset, an application processor subsystem, and a wireless communication manager. The wireless communication manager may establish a WLAN interface between the WLAN chipset and the application processor subsystem. The device may also include a modem subsystem to dynamically manage WLAN connectivity through the WLAN interface. In some examples, the device may include further components or configurations for implementing at least one aspect of the method for wireless communication described above with respect to the fifth set of illustrative examples.

In a seventh set of illustrative examples, a device for wireless communication is described. In one configuration, the device may include means for establishing a WLAN interface between a WLAN chipset and an application processor subsystem, and means for dynamically managing WLAN connectivity through the WLAN interface using a modem subsystem. In some examples, the device may further include means for implementing at least one aspect of the method for wireless communication described above with respect to the fifth set of illustrative examples.

In an eighth set of illustrative examples, another computer program product for communication by a wireless communication device in a wireless communication system is described. The computer program product may include a non-transitory computer-readable medium storing instructions executable by a processor to cause the wireless communication device to establish a WLAN interface between a WLAN chipset and an application processor subsystem, and dynamically manage WLAN connectivity through the WLAN interface using a modem subsystem. In some examples, the apparatus may further include means for implementing at least one aspect of the method for wireless communication described above with respect to the first set of illustrative examples.

Further scope of the applicability of the described methods and apparatuses will become apparent from the following detailed description, claims, and drawings. The detailed description and specific examples are given by way of illustration only, since various changes and modifications within the scope of the description will become apparent to those skilled in the art.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows a diagram of an example of a wireless communication system;

FIG. 2 shows another diagram of a wireless communication system;

FIG. 3 shows a wireless communication system in which a UE may simultaneously connect to an APN1 using a 3G/LTE/LTE-A network, to an APN2 using an S2a/S2b interface and a WLAN access network, and to the Internet using an NSWO connection, in accordance with various aspects of the present disclosure;

FIG. 4 shows an example DWD model in which a WLAN station is associated with an SSID managed by a HLOS, in accordance with various aspects of the present disclosure;

FIG. 5 shows an example DWD model in which a first WLAN station is associated with an SSID managed by a HLOS, and a second WLAN station is associated with an SSID managed by a modem subsystem, in accordance with various aspects of the present disclosure;

FIG. 6 shows the example DWD model in a scenario, in which the first WLAN station is not associated with an SSID, but the second WLAN station is associated with an SSID managed by the modem subsystem, in accordance with various aspects of the present disclosure;

FIG. 7 shows an example DWD model in which a single WLAN station may associate with an SSID managed by a HLOS or an SSID managed by a modem, in accordance with various aspects of the present disclosure;

FIG. 8 shows a block diagram of a device for use in wireless communication, in accordance with various aspects of the present disclosure;

FIG. 9 shows a block diagram of a device for use in wireless communication, in accordance with various aspects of the present disclosure;

FIG. 10 shows a block diagram of a device for use in wireless communication, in accordance with various aspects of the present disclosure;

FIG. 11 shows a block diagram of a device (e.g., a UE) for wireless communication, in accordance with various aspects of the present disclosure;

FIG. 12 is a flow chart illustrating an example of a method for wireless communication, in accordance with various aspects of the present disclosure;

FIG. 13 is a flow chart illustrating an example of a method for wireless communication, in accordance with various aspects of the present disclosure;

FIG. 14 is a flow chart illustrating an example of a method for wireless communication, in accordance with various aspects of the present disclosure; and

FIG. 15 is a flow chart illustrating an example of a method for wireless communication, in accordance with various aspects of the present disclosure.

### DETAILED DESCRIPTION

Management of wireless communications by a device such as a UE is described. The systems, methods, apparatuses, and devices disclosed herein may enable a UE having a modem subsystem to manage a WLAN interface established between an application processor subsystem and a WLAN chipset. Management of the WLAN interface by the modem subsystem may be facilitated by a WLAN management interface connecting the modem subsystem to an application processor WLAN driver of the application processor subsystem. The techniques disclosed herein may also or alternatively enable a modem subsystem to control a WLAN interface by, for example, specifying filters for routing data traffic to an application processor subsystem or the modem subsystem.

The following description provides examples, and is not limiting of the scope, applicability, or configuration set forth in the claims. Changes may be made in the function and arrangement of elements discussed without departing from the scope of the disclosure. Various embodiments may omit, substitute, or add various procedures or components as appropriate. For instance, the methods described may be performed in an order different from that described, and various steps may be added, omitted, or combined. Also, features described with respect to certain embodiments may be combined in other embodiments.

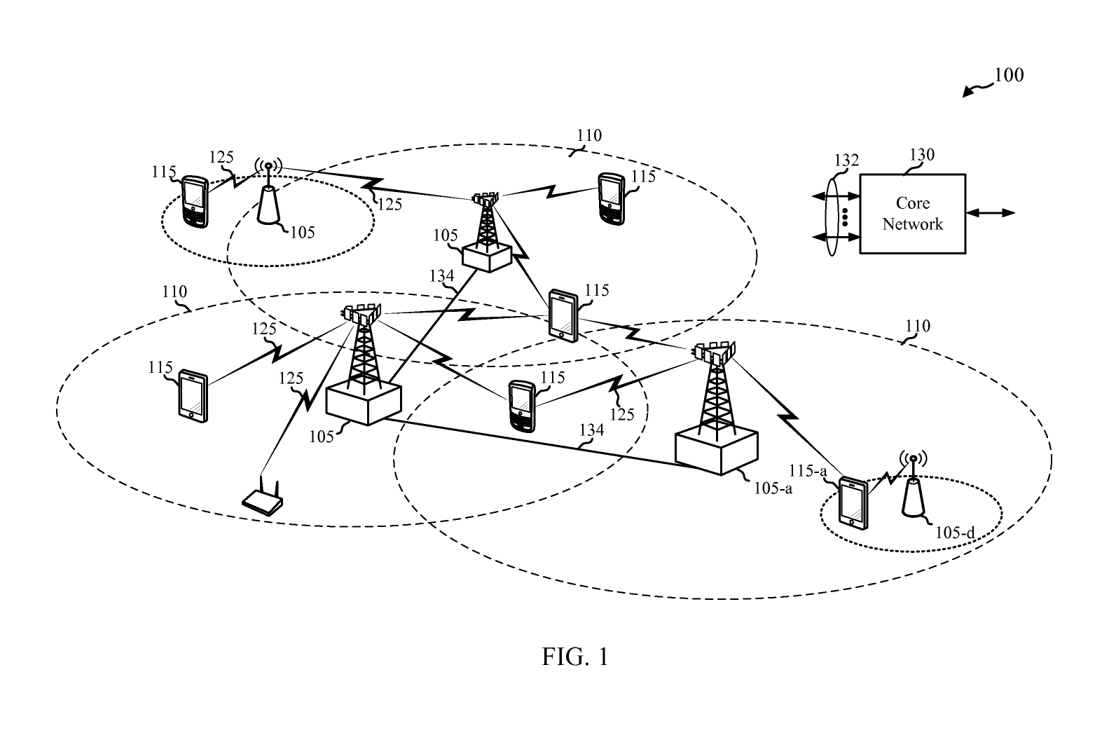

Referring first to FIG. 1, a diagram illustrates an example of a wireless communication system 100. The wireless communication system 100 includes a plurality of access points (e.g., base stations, eNBs, or WLAN access points) 105, a number of user equipments (UEs) 115, and a core network 130. Some of the access points 105 may communicate with the UEs 115 under the control of a base station controller (not shown), which may be part of the core network 130 or certain access points 105 (e.g., base stations or eNBs) in various examples. Some of the access points 105 may communicate control information or user data with the core network 130 through backhaul links 132. In some examples, some of the access points 105 may communicate, either directly or indirectly, with each other over backhaul links 134, which may be wired or wireless communication links. The wireless communication system 100 may support operation on multiple carriers (waveform signals of different frequencies). Multi-carrier transmitters can transmit modulated signals simultaneously on the multiple carriers. For example, each communication link 125 may be a multi-carrier signal modulated according to various radio technologies. Each modulated signal may be sent on a different carrier and may carry control information (e.g., reference signals, control channels, etc.), overhead information, data, etc.

The access points 105 may wirelessly communicate with the UEs 115 via at least one access point antenna. Each of the access points 105 may provide communication coverage for a respective geographic coverage area 110. In some examples, an access point 105 may be referred to as a base station, a base transceiver station (BTS), a radio base station, a radio transceiver, a basic service set (BSS), an extended service set (ESS), a NodeB, an evolved NodeB (eNB), a Home NodeB, a Home eNodeB, a WLAN access point, or some other suitable terminology. The coverage area 110 for an access point may be divided into sectors making up only a portion of the coverage area (not shown). The wireless communication system 100 may include access points 105 of different types (e.g., macro, micro, or pico base stations). The access points 105 may also utilize different radio technologies. The access points 105 may be associated with the same or different access networks. The coverage areas of different access points 105, including the coverage areas of the same or different types of access points 105, utilizing the same or different radio technologies, or belonging to the same or different access networks, may overlap.

In some examples, the wireless communication system 100 may be or include an LTE/LTE-A communication system (or network). In LTE/LTE-A communication systems, the term evolved Node B (eNB) may be generally used to describe the access points 105. The wireless communication system 100 may also be a Heterogeneous LTE/LTE-A network in which different types of eNBs provide coverage for various geographical regions. For example, each eNB 105 may provide communication coverage for a macro cell, a pico cell, a femto cell, or other types of cell. A macro cell generally covers a relatively large geographic area (e.g., several kilometers in radius) and may allow unrestricted access by UEs with service subscriptions with the network provider. A pico cell would generally cover a relatively smaller geographic area and may allow unrestricted access by UEs with service subscriptions with the network provider. A femto cell would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). An eNB for a macro cell may be referred to as a macro eNB. An eNB for a pico cell may be referred to as a pico eNB. And, an eNB for a femto cell may be referred to as a femto eNB or a home eNB. An eNB may support one or multiple (e.g., two, three, four, and the like) cells.

The core network 130 may communicate with the access points 105 via a backhaul link 132 (e.g., S1, etc.). The access points 105 may also communicate with one another, e.g., directly or indirectly via backhaul links 134 (e.g., X2, etc.) or via backhaul links 132 (e.g., through core network 130). The wireless communication system 100 may support synchronous or asynchronous operation. For synchronous operation, the access points may have similar frame timing, and transmissions from different access points may be approximately aligned in time. For asynchronous operation, the access points may have different frame timing, and transmissions from different access points may not be aligned in time. The techniques described herein may be used for either synchronous or asynchronous operations.

The UEs 115 may be dispersed throughout the wireless communication system 100, and each UE 115 may be stationary or mobile. A UE 115 may also be referred to by those skilled in the art as a mobile device, a mobile station, a subscriber station, a mobile unit, a subscriber unit, a wireless unit, a remote unit, a wireless device, a wireless communication device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a handheld device, a tablet computer, a laptop computer, a cordless phone, a wireless local loop (WLL) station, or the like. A UE may be able to communicate with macro eNBs, pico eNBs, femto eNBs, relays, and the like. A UE may also be able to communicate over different access networks, such as cellular or other WWAN access networks, or WLAN access networks.

The communication links 125 shown in wireless communication system 100 may include uplinks for carrying uplink (UL) transmissions (e.g., from a UE 115 to an access point 105) or downlinks for carrying downlink (DL) transmissions (e.g., from an access point 105 to a UE 115). The UL transmissions may also be called reverse link transmissions, while the DL transmissions may also be called forward link transmissions.

As shown, a UE 115-a may simultaneously or alternatively communicate with more than one access point 105-a, 105-d. For example, in some cases, a UE 115-a may simultaneously communicate with an access point or eNB 105-a of an LTE/LTE-A access network (i.e., a form of WWAN access network) and a WLAN access point (AP) 105-d of a WLAN access network. In some embodiments, a UE 115 such as the UE 115-a may manage data connectivity at the UE 115-a by establishing PDN connections of the UE 115-a over a WWAN access network, a WLAN access network, or both. The management of wireless communications and data connectivity at a UE 115 or other device is described in further detail below.

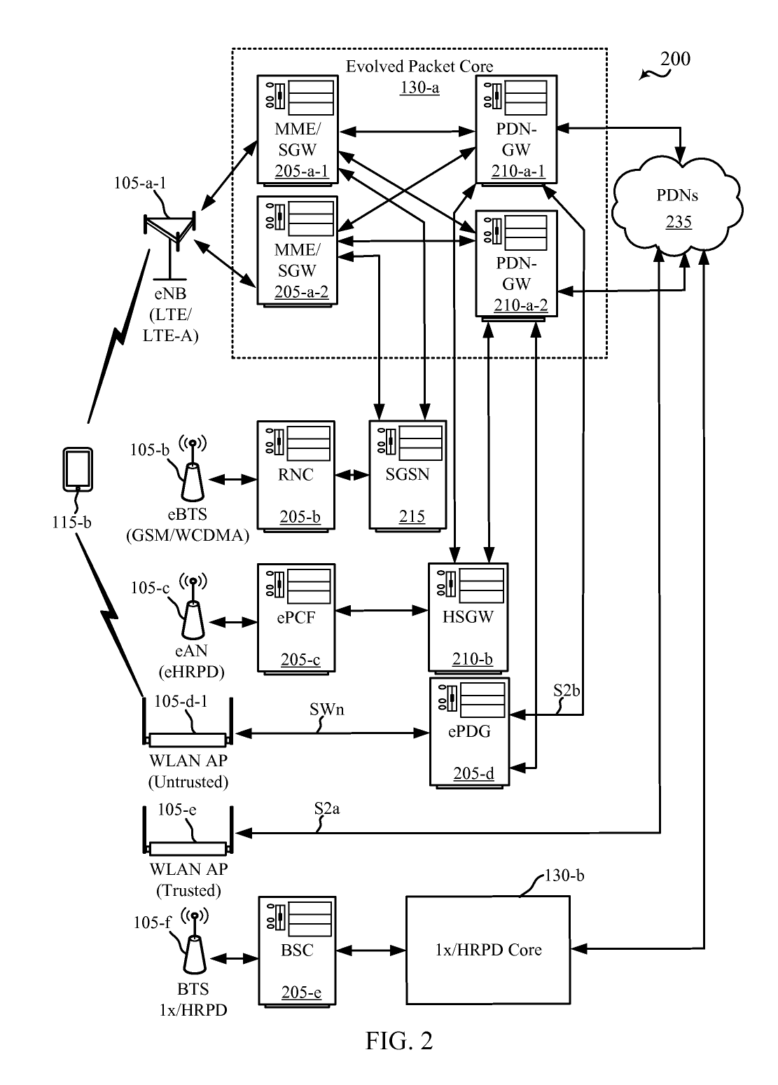

Referring now to FIG. 2, there is shown a wireless communication system 200. The wireless communication system 200 includes a UE 115-b, an enhanced packet core (EPC) 130-a, a 1x/HRPD packet core 130-b, as well as a number of access points 105, a number of controllers 205, a number of gateways 210, and a number of PDNs 235. The access points 105 may include an eNB 105-a-1 associated with an LTE access network, an enhanced Base Transceiver Station (eBTS) 105-b associated with a GSM or WCDMA access network, an evolved Access Node (eAN) 105-c associated with an eHRPD access network, a WLAN access point 105-d-1 associated with an untrusted WLAN access network, a WLAN access point 105-e associated with a trusted WLAN access network, and a Base Transceiver Station (BTS) 105-f associated with a 1x/HRPD or 1x only access network.

The enhanced packet core 130-a may include a number of devices 205-a implementing Mobile Management Entities (MMEs) and Serving Gateways (SGWs). Alternatively, the MMEs and SGWs may be implemented in separate devices. The SGWs may in turn be in communication with Packet Data Network Gateways (PDN-GWs) 210-a-1, 210-a-2. Each of the PDN-GWs 210-a-1, 210-a-2 may be in communication with PDNs 235.

The eNB 105-a-1 may access the EPC 130-a through a direct connection to the MME/SGW devices 205-a. The eBTS 105-b may be in communication with a Radio Network Controller (RNC) 205-b, which in turn may communicate with a Serving GPRS Support Node (SGSN) 215 to access the EPC 130-a through MME/SGs 205-a. The eAN 105-c may be in communication with an evolved Packet Control Function (ePCF) 205-c, which may communicate with a HRPD Serving Gateway (HSGW) 210-b to access the EPC 130-a through PDN-GWs 210-a. The untrusted WLAN access point 105-d-1 may communicate with an evolved Packet Data Gateway (ePDG) 205-d via an SWn interface, which may provide access to the EPC 130-a via an S2b interface and the PDN-GWs 210-a. The trusted WLAN access point 105-e may bypass the EPC 130-a and may communicate directly with the PDNs 235, or may communicate with the PDNs 235 through PDN-GWs 210-a. The BTS 105-f may be in communication with a BSC 205-e, which may be in communication with a core network 130-b (e.g., a 1x/HRPD core network). The core network 130-b may be in communication with the PDNs 235.

Each of the eNB 105-a-1, eBTS 105-b, eAN 105-c, and BTS 105-f may provide access to a WWAN access network, whereas each of the WLAN APs 105-d-1, 105-e may provide access to a WLAN access network. The eNB 105-a-1 may provide access to an LTE/LTE-A (WWAN) access network, whereas the eBTS 105-b, eAN 105-c, and BTS 105-f may provide access to non-LTE/LTE-A WWAN access networks. The eNB 105-a-1, eBTS 105-b, and eAN 105-c may provide access to EPC-capable WWAN access networks, whereas the BTS 105-f may provide access to a non-EPC-capable WWAN access network.

In some embodiments, a UE 115 such as the UE 115-b may establish PDN connections with more than one of the eNB 105-a-1, eBTS 105-b, eAN 105-c, WLAN AP 105-d-1, WLAN AP 105-e, BTS 105-f, or other access points 105 (e.g., the UE 115-b may support multi-access PDN connectivity (MAPCON)). PDN connections over different access networks may be established using different service set identifiers (SSIDs) or Access Point Names (APNs). In some embodiments, a UE 115 may establish or maintain PDN connections with more than one access point simultaneously.

A UE 115 such as the UE 115-b may have preferences for accessing access networks to establish data connectivity. The preferences may be based on network operator policies. Using the preferences, the UE 115-b may establish data connectivity over a most preferred available system and maintain data connectivity continuity.

In some examples, a trusted WLAN access point 105-e may include a network operator (operator owned/managed) WLAN access point, and an untrusted WLAN access point 105-d-1 may include a privately owned/managed WLAN access point (e.g., a WLAN access point in a home or business). When a UE such as the UE 115-b is camped on a trusted WLAN access point or an untrusted WLAN access point, the UE 115-b may perform seamless EPC-routed WLAN offload of traffic by establishing a WLAN connection to a PDN-GW 210-a through an S2a (trusted)/S2b (untrusted)/S2c (trusted or untrusted) interface. With respect to mobility, S2b mobility via the ePDG 205-d may require the UE 115-b to establish an Internet Protocol Security (IPsec) tunnel with the ePDG 205-d. S2a mobility based on General Packet Radio Service (GPRS) Tunneling Protocol (GTP) (SaMOG) may require the UE 115-b to establish a layer 2 tunnel with a trusted WLAN access network (TWAN), but may not require the UE 115-b to establish an end-to-end L3 secure tunnel between the UE and a PDN-GW 210-a to access the EPC 130-a. Using either S2b mobility using the ePDG 205-d or S2a mobility based on GTP (SaMOG), the UE 115-b can achieve IP continuity as the UE 115-b hands over between WWAN access (e.g., 3rd Generation Partnership Project (3GPP) access) and WLAN access.

In addition to EPC-routed WLAN offload, optionally, the UE 115-b may also provide a Non-Seamless WLAN Offload (NSWO) connection, i.e., the UE 115-b may route IP flows to Internet directly via a WLAN access network, without going through the EPC. For such IP flows, IP address preservation between WLAN and 3GPP access may not be provided. An IP address used by such a flow may be the local address assigned by the WLAN access network. An NSWO connection is also known as a local breakout (LBO) connection.

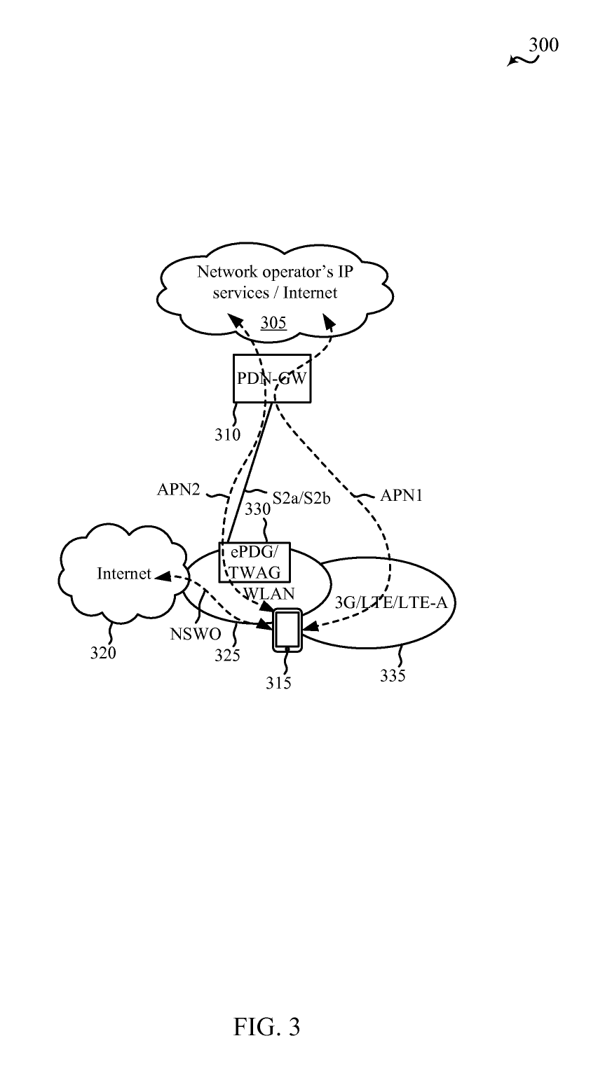

FIG. 3 shows a wireless communication system 300 in which a UE 315 may simultaneously connect to an APN1 using a 3G/LTE/LTE-A network 335, to an APN2 using an S2a/S2b interface and a WLAN access network 325, and to the Internet 320 using an NSWO connection, in accordance with various aspects of the present disclosure. The 3G/LTE/LTE-A network 335 may wirelessly connect to a PDN-GW 310 providing access to a network operator's IP services or the Internet 305. The WLAN access network 325 may connect to an ePDG or trusted WLAN access gateway (TWAG) 330 that wirelessly connects to the PDN-GW 310 via an S2a/S2b interface. The WLAN access network 325 may also provide direct access to the Internet 320 via the NSWO connection.

A WLAN interface of a UE is typically controlled by an application processor (AP) subsystem and high level operating system (HLOS) of the UE, regardless of whether the WLAN interface is servicing a WLAN connection with a WLAN access point operated by a user (e.g., at home), by a business owner, by a dedicated Wi-Fi hotspot operator, or by a network operator (e.g., a PLMN operator or MNO). Described herein are systems, methods, apparatuses, and devices that enable a modem subsystem of the UE to manage or control at least part of a WLAN interface, particularly when the WLAN interface is servicing an operator owned WLAN connection (e.g., a WLAN connection with a WLAN access point operated by a network operator.

Management or control of at least part of a WLAN interface, by a modem subsystem, may be facilitated by control of the WLAN interface at a WLAN chipset or control of the WLAN interface at or via the AP subsystem. In some examples, the techniques described herein may employ a data path (e.g., a high bandwidth data path) between a WLAN chipset and modem subsystem of a UE, which data path bypasses an AP subsystem of the UE. The data path between the WLAN chipset and the modem subsystem may establish a second WLAN interface with the WLAN chipset (with the first WLAN interface being established between the WLAN chipset and the AP subsystem). At least one filter may be installed in the WLAN chipset, or in the data path between the WLAN chipset and the modem subsystem. Data packets (e.g., downlink data packets) may then be routed to the AP subsystem or the modem subsystem based at least in part on filter matching. In some examples, the at least one filter may be specified by the AP subsystem or the modem subsystem.

In some examples, the techniques described herein may enable an AP subsystem to offload the complexity of managing diversified network operator requirements related to WWAN-WLAN interworking from the AP subsystem to a modem subsystem (e.g., from a HLOS to a modem). Such an offload, from the AP subsystem to the modem subsystem, may allow the HLOS to forego an implementation of software for the different standards options and requirements of different network operators.

In some examples, the techniques described herein may be facilitated by a distributed WLAN driver (DWD) model, which DWD model may provide a data path, and in some cases a control interface, between a WLAN chipset and a modem subsystem (e.g., a WLAN chipset and a modem subsystem of a UE). Thus, a DWD model may enable a UE to establish a first WLAN interface between a WLAN chipset and an AP subsystem, and establish a second WLAN interface between the WLAN chipset and a modem subsystem.

In some examples, a WLAN chipset may include a first WLAN station interface (e.g., a ST1 interface) and a second WLAN station interface (e.g., a STA2 interface). Each of the STA1 interface and the STA2 interface may in some cases be associated with a respective first service set identifier (SSID) or second SSID. In some examples, a HLOS SSID (i.e., an SSID managed by a HLOS) may be associated with one or both of the STA1 interface and the STA2 interface. In some examples, a modem SSID (i.e., an SSID managed by a modem) may be associated with one or both of the STA1 interface and the STA2 interface. In some examples, a modem SSID may be associated with one but not both of the STA1 interface and the STA2 interface (e.g., a modem SSID may be associated with the STA2 interface).

Table 1 provides various examples of how a WLAN chipset may be configured, and indicates, for example, various associations between WLAN station interfaces and SSIDs. As shown, the associations may be dependent on whether the WLAN chipset is powered ON or OFF; whether a first WLAN station (STA1) association capability (STA1 Association) is allowed or disallowed (e.g., ON or OFF); whether a second WLAN station (STA2) association capability (STA2_Association) is allowed or disallowed (e.g., ON or OFF); or a priority (STA2_Priority) of associating a second WLAN station interface (STA2 interface) with a HLOS SSID compared to associating the second WLAN station interface with a modem SSID.

TABLE 1

| Configuration | Configuration | STA1 Enabled | STA2 Enabled |
|---|---|---|---|
| WLAN Power OFF | | OFF | OFF |
| WLAN POWER ON | STA1_Association = | ON | ON |
| | OFF/ON; | allow association if | allow association if |
| | STA2_Association = | STA1_Assoc is ON; | STA2_Assoc is ON; |
| | OFF/ON | disallow association | disallow association |
| | | if STA1_Assoc is | if STA2_Assoc is |
| | | OFF | OFF |
| WLAN POWER ON | STA2 Priority = | HLOS SSID | HLOS SSID > |
| STA1_Association = | HLOS Preferred | | Modem SSID |
| ON | STA2 Priority = | HLOS SSID | Modem SSID > |
| STA2_Association = | Modem Preferred | | HLOS SSID |
| ON | STA2 Priority = | HLOS SSID | HLOS SSID |
| | HLOS Only | | |
| | STA2 Priority = | HLOS SSID | Modem SSID |
| | Modem Only | | |
| WLAN POWER ON | STA2 Priority = | ON | HLOS SSID > |
| STA1_Association = | HLOS Preferred | (may be used for | Modem SSID |
| OFF | | scanning; no | |
| STA2_Association = | | association) | |
| ON | STA2 Priority = | ON | Modem SSID > |
| | Modem Preferred | (may be used for | HLOS SSID |
| | | scanning; no | |
| | | association) | |
| | STA2 Priority = | ON | HLOS SSID |
| | HLOS Only | (may be used for | |
| | | scanning; no | |
| | | association) | |
| | STA2 Priority = | ON | Modem SSID |
| | Modem Only | (may be used for | |
| | | scanning; no | |
| | | association) | |
| WLAN POWER ON | STA2 Priority = | HLOS SSID | ON |
| STA1_Association = | HLOS Preferred | | (may be used for |
| ON | | | scanning; no |
| STA2_Association = | | | association) |
| OFF | STA2 Priority = | HLOS SSID | ON |
| | Modem Preferred | | (may be used for |
| | | | scanning; no |
| | | | association) |
| | STA2 Priority = | HLOS SSID | ON |
| | HLOS Only | | (may be used for |
| | | | scanning; no |
| | | | association) |
| | STA2 Priority = | HLOS SSID | ON |
| | Modem Only | | (may be used for |
| | | | scanning; no |
| | | | association) |

In the following description, a WLAN station associated with a HLOS SSID may be referred to as a STA_HLOS, and a WLAN station associated with a modem SSID may be referred to as a STA_modem.

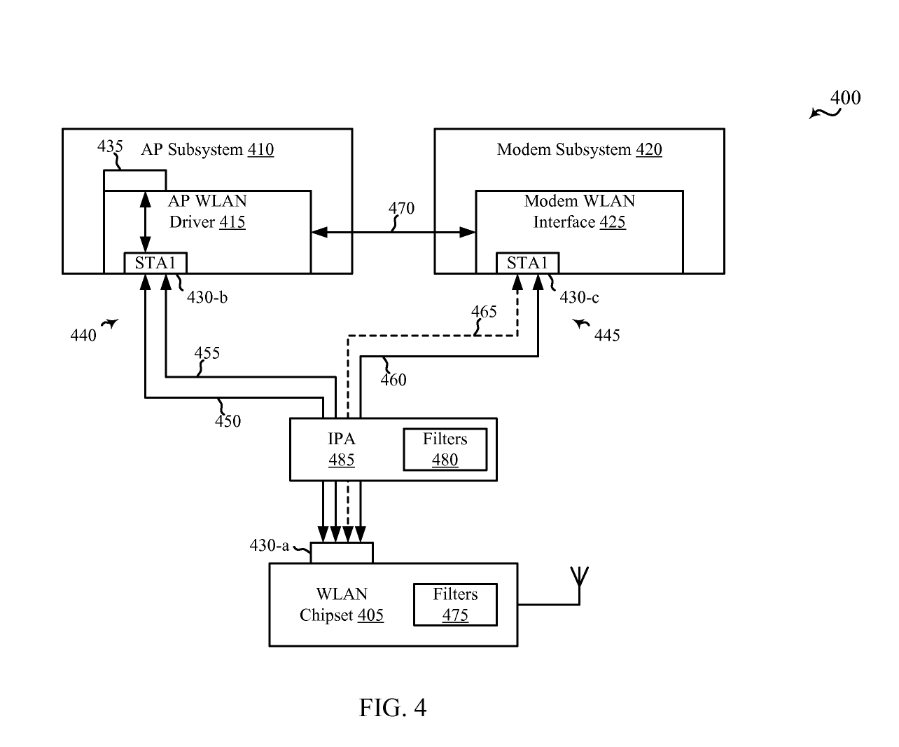

FIG. 4 shows an example DWD model 400 in which a WLAN station 430 is associated with an SSID managed by a HLOS, in accordance with various aspects of the present disclosure. The DWD model 400 may be implemented by a UE, such as one of the UEs described with reference to FIG. 1, 2, or 3. As shown, the DWD model 400 may include various connections between a WLAN chipset 405, an AP subsystem 410 (and more particularly, an AP WLAN driver 415 of the AP subsystem 410), and a modem subsystem 420 (and more particularly, a modem WLAN interface 425 of the modem subsystem 420).

In the DWD model 400, a STA_HLOS formed by associating the WLAN station 430 with a HLOS SSID may be established under control of a supplicant 435 (e.g., a connection manager in the HLOS of the AP subsystem 410). As shown, the WLAN station 430 may include parts of the WLAN chipset 405 (e.g., the STA1 interface 430-a), parts of the AP subsystem 410 (e.g., the STA1 controller 430-b of the AP WLAN driver 415), and parts of the modem subsystem 420 (e.g., the STA1 controller 430-c of the modem WLAN interface 425). After successful association and authentication, a first WLAN interface 440 may be established between the WLAN chipset 405 and the AP subsystem 410. In addition, a second WLAN interface 445 may be established between the WLAN chipset 405 and the modem subsystem 420. The first WLAN interface 440 and the second WLAN interface 445 may be established with the same WLAN association.

The first WLAN interface 440 may include a data interface 450 and a control interface 455. The second WLAN interface 445 may include a data interface 460 that bypasses the AP subsystem 410 (e.g., a direct digital interconnect such as a peripheral component interconnect express (PCIe) interface, which provides a direct data path between the WLAN chipset 405 and the modem subsystem 420). The second WLAN interface 445 may also include a control interface 465. Additionally or alternatively to the control interface 465, a control interface 470 may be provided between the modem subsystem 420 and the AP subsystem 410 (and more particularly, between the modem WLAN interface 425 and the AP WLAN driver 415). The control interface 465 or 470 may enable control of part or all of the first WLAN interface 440 (i.e., the WLAN interface between the WLAN chipset 405 and the AP subsystem 410) by the modem subsystem 420. When the first WLAN interface 440 is controlled by the modem subsystem 420 via the control interface 470, the control may be provided by the modem subsystem 420 via the AP subsystem 410 (and more particularly, via the AP WLAN driver 415).

WLAN management (e.g., scanning, association, authentication, etc.) may be carried out by the AP WLAN driver 415 of the AP subsystem 410. In some examples, the AP WLAN driver 415 may provide a control interface to install filters 475 (e.g., traffic filters) in the WLAN chipset 405. Additionally or alternatively, filters 480 may be installed in the data path between the modem WLAN interface 425 and the WLAN chipset 405 (e.g., in an IPA 485 in the data path). The filter(s) 475 or 480 may be used to route data packets received by the WLAN chipset 405 to the AP subsystem 410 or the modem subsystem 420. The routing of data packets may be based on filter matching. In some cases, the filters may be specified by either or both of the AP subsystem 410 and the modem subsystem 420. When specified by the modem subsystem 420, a filter may be provided to the WLAN chipset 405 (e.g., for installation), by the modem subsystem 420 (e.g., the modem WLAN interface 425 of the modem subsystem 420), via the control interface 465. Alternatively, a filter may be provided to the AP subsystem 410, by the modem subsystem 420 (e.g., by the modem WLAN interface 425), via the control interface 470, and then provided to the WLAN chipset 405, by the AP subsystem 410, via the control interface 455.

When a filter is installed in the WLAN chipset 405 or the data path between the modem WLAN interface 425 and the WLAN chipset 405, in accordance with the DWD model 400, the second WLAN interface 445 may send and receive data packets to and from the WLAN chipset 405, but may not perform any WLAN management functions.

In use, WLAN traffic may flow through the WLAN chipset 405, to and from the AP subsystem 410 or the modem subsystem 420. When WLAN traffic associated with the AP subsystem 410 does not exist (e.g., is absent), the AP subsystem 410 may be transitioned to a power saving mode.

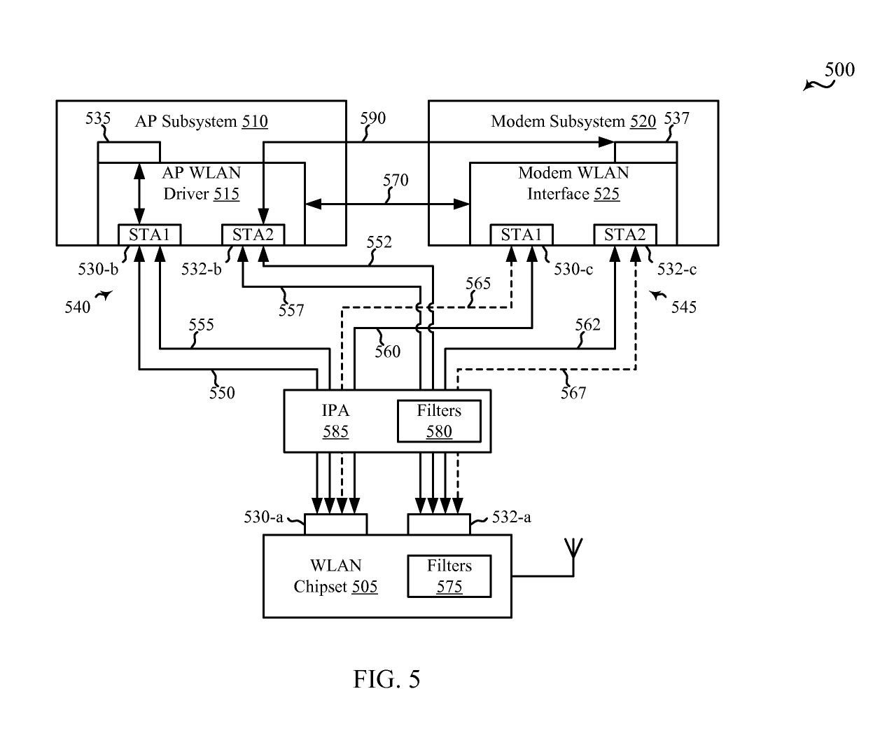

FIG. 5 shows an example DWD model 500 in which a first WLAN station 530 is associated with an SSID managed by a HLOS (i.e., STA_HLOS), and a second WLAN station 532 is associated with an SSID managed by a modem subsystem 520 (i.e., STA_modem), in accordance with various aspects of the present disclosure. The DWD model 500 may be implemented by a UE, such as one of the UEs described with reference to FIG. 1, 2, or 3. As shown, the DWD model 500 may include various connections between a WLAN chipset 505, an AP subsystem 510 (and more particularly, an AP WLAN driver 515 of the AP subsystem 510), and a modem subsystem 520 (and more particularly, a modem WLAN interface 525 of the modem subsystem 520).

In the DWD model 500, a STA_HLOS formed by associating the WLAN station 530 with a HLOS SSID may be established under control of a supplicant 535 (e.g., a connection manager in the HLOS of the AP subsystem 510). As shown, the WLAN station 530 may include parts of the WLAN chipset 505 (e.g., the STA1 interface 530-a), parts of the AP subsystem 510 (e.g., the STA1 controller 530-b of the AP WLAN driver 515), and parts of the modem subsystem 520 (e.g., the STA1 controller 530-c of the modem WLAN interface 525).

Also in the DWD model 500, a STA_modem formed by associating the WLAN station 532 with a modem SSID may be established under control of a supplicant 537 of the modem subsystem 520. As shown, the WLAN station 532 may include parts of the WLAN chipset 505 (e.g., the STA2 interface 532-a), parts of the AP subsystem 510 (e.g., the STA2 controller 532-b of the AP WLAN driver 515), and parts of the modem subsystem 520 (e.g., the STA2 controller 532-c of the modem WLAN interface 525).

After successful association and authentication, a first WLAN interface 540 may be established between the WLAN chipset 505 and the AP subsystem 510. In addition, a second WLAN interface 545 may be established between the WLAN chipset 505 and the modem subsystem 520. The first WLAN interface 540 and the second WLAN interface 545 may be established with the same WLAN association.

The first WLAN interface 540 may include a STA1 data interface 550, a STA1 control interface 555, a STA2 data interface 552, and a STA2 control interface 557. The second WLAN interface 545 may include a STA1 data interface 560 and STA2 data interface 562 that bypass the AP subsystem 510 (e.g., direct digital interconnects such as peripheral component interconnect express (PCIe) interfaces, which provide direct data paths between the WLAN chipset 505 and the modem subsystem 520 via each of the first WLAN station 530 and the second WLAN station 532). The second WLAN interface 545 may also include a STA1 control interface 565 or a STA2 control interface 567. Additionally or alternatively to the control interfaces 565 and 567, a control interface 570 may be provided between the modem subsystem 520 and the AP subsystem 510 (and more particularly, between the modem WLAN interface 525 and the AP WLAN driver 515). The control interface 565, 567, or 570 may enable control of part or all of the first WLAN interface 540 (i.e., the WLAN interface between the WLAN chipset 505 and the AP subsystem 510) by the modem subsystem 520. When the first WLAN interface 540 is controlled by the modem subsystem 520 via the control interface 570, the control may be provided by the modem subsystem 520 via the AP subsystem 510 (and more particularly, via the AP WLAN driver 515).

In some examples, when a UE is connected to a WLAN network on the first WLAN station 530 associated with an operator managed SSID (i.e., the STA_HLOS) and on the second WLAN station 532 associated a modem managed SSID (i.e., the STA_modem), WLAN management of the first WLAN station 530 (e.g., scanning, association, authentication, etc.) may be carried out by the AP WLAN driver 515 of the AP subsystem 510, whereas WLAN management of the second WLAN station 532 (e.g., scanning, association, authentication, etc.) may be carried out by the supplicant 537 of the modem subsystem 520, via the WLAN management interface 590 and the AP WLAN driver 515 of the AP subsystem 510. In some examples, the AP WLAN driver 515 may hide a WLAN connection of the second WLAN station 532 from the HLOS of the AP subsystem, thereby allowing the HLOS to presume that traffic on the second WLAN station 532 is being sent and received via the modem subsystem 520.

In some examples, the AP WLAN driver 515 may provide a control interface to install filters 575 (e.g., traffic filters) in the WLAN chipset 505. Additionally or alternatively, filters 580 may be installed in the data path between the modem WLAN interface 525 and the WLAN chipset 505 (e.g., in an IPA 585 in the data path of the data interface 560 or 562). The filter(s) 575 or 580 may be used to route data packets received by the WLAN chipset 505 to the AP subsystem 510 or the modem subsystem 520. The routing of data packets may be based on filter matching. In some cases, the filters may be specified by either or both of the AP subsystem 510 and the modem subsystem 520. When specified by the modem subsystem 520, a filter may be provided to the WLAN chipset 505 (e.g., for installation), by the modem subsystem 520 (e.g., the modem WLAN interface 525 of the modem subsystem 520), via the control interface 565 or 567. Alternatively, a filter may be provided to the AP subsystem 510, by the modem subsystem 520 (e.g., by the modem WLAN interface 525), via the control interface 570, and then provided to the WLAN chipset 505, by the AP subsystem 510, via the control interface 555.

When a filter for the data interface 560 is installed in the WLAN chipset 505 or the data path between the modem WLAN interface 525 and the WLAN chipset 505, in accordance with the DWD model 500, the second WLAN interface 545 may send and receive data packets to and from the WLAN chipset 505 via the first WLAN station 530, but may not perform any WLAN management functions for the first WLAN station 530. When a filter for the data interface 562 is installed in the WLAN chipset 505 or the data path between the modem WLAN interface 525 and the WLAN chipset 505, in accordance with the DWD model 500, the second WLAN interface 545 may send and receive data packets to and from the WLAN chipset 505 via the second WLAN station 532 and also perform WLAN management functions for the second WLAN station 532.

In use, WLAN traffic may flow through the WLAN chipset 505, to and from the AP subsystem 510 or the modem subsystem 520. When WLAN traffic associated with the AP subsystem 510 does not exist (e.g., is absent), the AP subsystem 510 may be transitioned to a power saving mode.

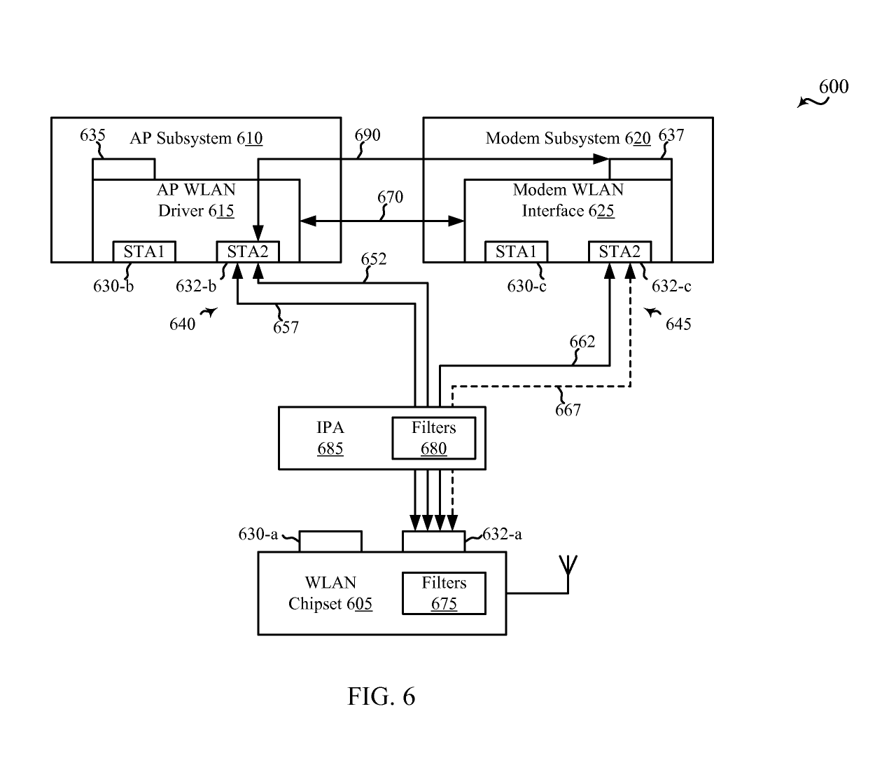

FIG. 6 shows the example DWD model 600 in a scenario, in which the first WLAN station 530 is not associated with an SSID, but the second WLAN station 632 is associated with an SSID managed by the modem subsystem 620, in accordance with various aspects of the present disclosure. The DWD model 600 may be implemented by a UE, such as one of the UEs described with reference to FIG. 1, 2, or 3. As shown, the DWD model 600 may include various connections between a WLAN chipset 605, an AP subsystem 610 (and more particularly, an AP WLAN driver 615 of the AP subsystem 610), and a modem subsystem 620 (and more particularly, a modem WLAN interface 625 of the modem subsystem 620).

In the DWD model 600, a UE is connected only to a single WLAN network through a second WLAN station associating with a modem managed SSID (i.e., STA_modem only). The STA_modem formed by associating the WLAN station 632 with a modem SSID may be established under control of a supplicant 637 of the modem subsystem 620.

After successful association and authentication, a first WLAN interface 640 may be established between the WLAN chipset 605 and the AP subsystem 610. In addition, a second WLAN interface 645 may be established between the WLAN chipset 605 and the modem subsystem 620. The first WLAN interface 640 and the second WLAN interface 645 may be established with the same WLAN association.

The first WLAN interface 640 may include a STA2 data interface 652 and a STA2 control interface 657. The second WLAN interface 645 may include a STA2 data interface 662 that bypass the AP subsystem 610 (e.g., a direct digital interconnect such as a peripheral component interconnect express (PCIe) interface, which provides a direct data path between the WLAN chipset 605 and the modem subsystem 620 via the second WLAN station 632). The second WLAN interface 645 may also include a STA2 control interface 667. Additionally or alternatively to the control interface 667, a control interface 670 may be provided between the modem subsystem 620 and the AP subsystem 610 (and more particularly, between the modem WLAN interface 625 and the AP WLAN driver 615). The control interface 667 or 670 may enable control of part or all of the first WLAN interface 640 (i.e., the WLAN interface between the WLAN chipset 605 and the AP subsystem 610) by the modem subsystem 620. When the first WLAN interface 640 is controlled by the modem subsystem 620 via the control interface 670, the control may be provided by the modem subsystem 620 via the AP subsystem 610 (and more particularly, via the AP WLAN driver 615).

In some examples, WLAN management (e.g., scanning, association, authentication, etc.) on the STA_modem may be carried out by the supplicant 637 of the modem subsystem 620, via the WLAN management interface 690 and the AP WLAN driver 615 of the AP subsystem 610. In some examples, the AP WLAN driver 615 may hide a WLAN connection of the second WLAN station 632 from the HLOS of the AP subsystem, thereby allowing the HLOS to presume that traffic on the second WLAN station 632 is being sent and received via the modem subsystem 620.

In some examples, the AP WLAN driver 615 may provide a control interface to install filters 675 (e.g., traffic filters) in the WLAN chipset 605. Additionally or alternatively, filters 680 may be installed in the data path between the modem WLAN interface 625 and the WLAN chipset 605 (e.g., in an IPA 685 in the data path of the data interface 662). The filter(s) 675 or 680 may be used to route data packets received by the WLAN chipset 605 to the AP subsystem 610 or the modem subsystem 620. The routing of data packets may be based on filter matching. In some cases, the filters may be specified by either or both of the AP subsystem 610 and the modem subsystem 620. When specified by the modem subsystem 620, a filter may be provided to the WLAN chipset 605 (e.g., for installation), by the modem subsystem 620 (e.g., the modem WLAN interface 625 of the modem subsystem 620), via the control interface 667. Alternatively, a filter may be provided to the AP subsystem 610, by the modem subsystem 620 (e.g., by the modem WLAN interface 625), via the control interface 670, and then provided to the WLAN chipset 605, by the AP subsystem 610, via the control interface 652.

When a filter for the data interface 662 is installed in the WLAN chipset 605 or the data path between the modem WLAN interface 625 and the WLAN chipset 605, in accordance with the DWD model 600, the second WLAN interface 645 may send and receive data packets to and from the WLAN chipset 605 via the second WLAN station 632 and also perform WLAN management functions for a WLAN connectivity on the second WLAN station 632 (i.e., STA_modem).

In use, WLAN traffic may flow through the WLAN chipset 605, to and from the AP subsystem 610 or the modem subsystem 620. When WLAN traffic associated with the AP subsystem 610 does not exist (e.g., is absent), the AP subsystem 610 may be transitioned to a power saving mode.

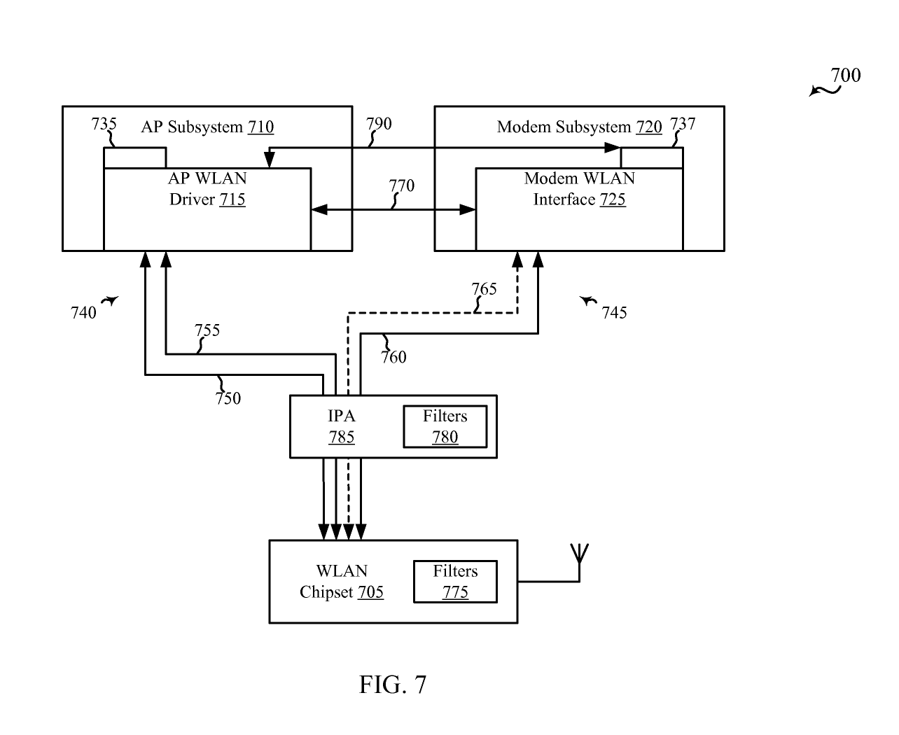

FIG. 7 shows an example DWD model 700 in which a single WLAN station may associate with an SSID managed by a HLOS or an SSID managed by a modem, in accordance with various aspects of the present disclosure. The DWD model 700 may be implemented by a UE, such as one of the UEs described with reference to FIG. 1, 2, or 3. As shown, the DWD model 700 may include various connections between a WLAN chipset 705, an AP subsystem 710 (and more particularly, an AP WLAN driver 715 of the AP subsystem 710), and a modem subsystem 720 (and more particularly, a modem WLAN interface 725 of the modem subsystem 720).

In the DWD model 700, a STA_HLOS may be formed by associating the WLAN station with a HLOS SSID under control of a supplicant 735 (e.g., a connection manager in the HLOS of the AP subsystem 710). Alternatively, a STA_modem may be formed by associating the WLAN station with a modem SSID. The STA_modem may be formed by means of the modem supplicant 737 transferring at least one modem SSID from the modem subsystem 720 to the AP WLAN driver 715 of the AP subsystem 710 and letting the AP WLAN driver prioritize the at least one modem SSID with respect to at least one HLOS SSID. If the AP WLAN driver associates the single WLAN station with a HLOS SSID, WLAN management (e.g., scanning, association, authentication, etc.) may be carried out by the AP WLAN driver 715 of the AP subsystem 710. If the AP WLAN driver 715 associates the single WLAN station with a modem SSID, WLAN management (e.g., scanning, association, authentication, etc.) may be carried out by the modem supplicant 737 of the modem subsystem 720, via the WLAN management interface 790 and the AP WLAN driver 715 of the AP subsystem 710. In some examples, the AP WLAN driver 715 may hide a WLAN connection associated with a modem SSID from the HLOS of the AP subsystem 710, thereby allowing the HLOS to presume that traffic on the single WLAN station is being sent and received via the modem subsystem 720.

After successful association and authentication, a first WLAN interface 740 may be established between the WLAN chipset 705 and the AP subsystem 710. In addition, a second WLAN interface 745 may be established between the WLAN chipset 705 and the modem subsystem 720. The first WLAN interface 740 and the second WLAN interface 745 may be established with the same WLAN association. The first WLAN interface 740 may include a data interface 750 and a control interface 755. The second WLAN interface 745 may include a data interface 760 that bypasses the AP subsystem 710 (e.g., a direct digital interconnect such as a peripheral component interconnect express (PCIe) interface, which provides a direct data path between the WLAN chipset 705 and the modem subsystem 720). The second WLAN interface 745 may also include a control interface 765. Additionally or alternatively to the control interface 765, a control interface 770 may be provided between the modem subsystem 720 and the AP subsystem 710 (and more particularly, between the modem WLAN interface 725 and the AP WLAN driver 715). The control interface 765 or 770 may enable control of part or all of the first WLAN interface 740 (i.e., the WLAN interface between the WLAN chipset 705 and the AP subsystem 710) by the modem subsystem 720. When the first WLAN interface 740 is controlled by the modem subsystem 720 via the control interface 770, the control may be provided by the modem subsystem 720 via the AP subsystem 710 (and more particularly, via the AP WLAN driver 715).

In some examples, the AP WLAN driver 715 may provide a control interface to install filters 775 (e.g., traffic filters) in the WLAN chipset 705. Additionally or alternatively, filters 780 may be installed in the data path between the modem WLAN interface 725 and the WLAN chipset 705 (e.g., in an IPA 785 in the data path). The filter(s) 775 or 780 may be used to route data packets received by the WLAN chipset 705 to the AP subsystem 710 or the modem subsystem 720. The routing of data packets may be based on filter matching. In some cases, the filters may be specified by either or both of the AP subsystem 710 and the modem subsystem 720. When specified by the modem subsystem 720, a filter may be provided to the WLAN chipset 705 (e.g., for installation), by the modem subsystem 720 (e.g., the modem WLAN interface 725 of the modem subsystem 720), via the control interface 765. Alternatively, a filter may be provided to the AP subsystem 710, by the modem subsystem 720 (e.g., by the modem WLAN interface 725), via the control interface 770, and then provided to the WLAN chipset 705, by the AP subsystem 710, via the control interface 755.

When an association with a modem SSID takes priority over an association with a HLOS SSID on the WLAN chipset 705, in accordance with the DWD model 700, the second WLAN interface 745 may send and receive data packets to and from the WLAN chipset 705 and may also perform WLAN management functions. In some examples, the modem subsystem 720 of the modem subsystem 720 may provide a list of modem managed SSIDs to the AP WLAN driver 715. When the AP WLAN driver 715 associates with a modem SSID, the AP WLAN driver 715 may notify the modem supplicant 737 of the association with a modem SSID without being known to HLOS. Upon the notification, WLAN management (e.g., scanning, association, authentication, etc.) may be carried out by the modem supplicant 737 of the modem subsystem 720.

In use, WLAN traffic may flow through the WLAN chipset 705, to and from the AP subsystem 710 or the modem subsystem 720. When WLAN traffic associated with the AP subsystem 710 does not exist (e.g., is absent), the AP subsystem 710 may be transitioned to a power saving mode.

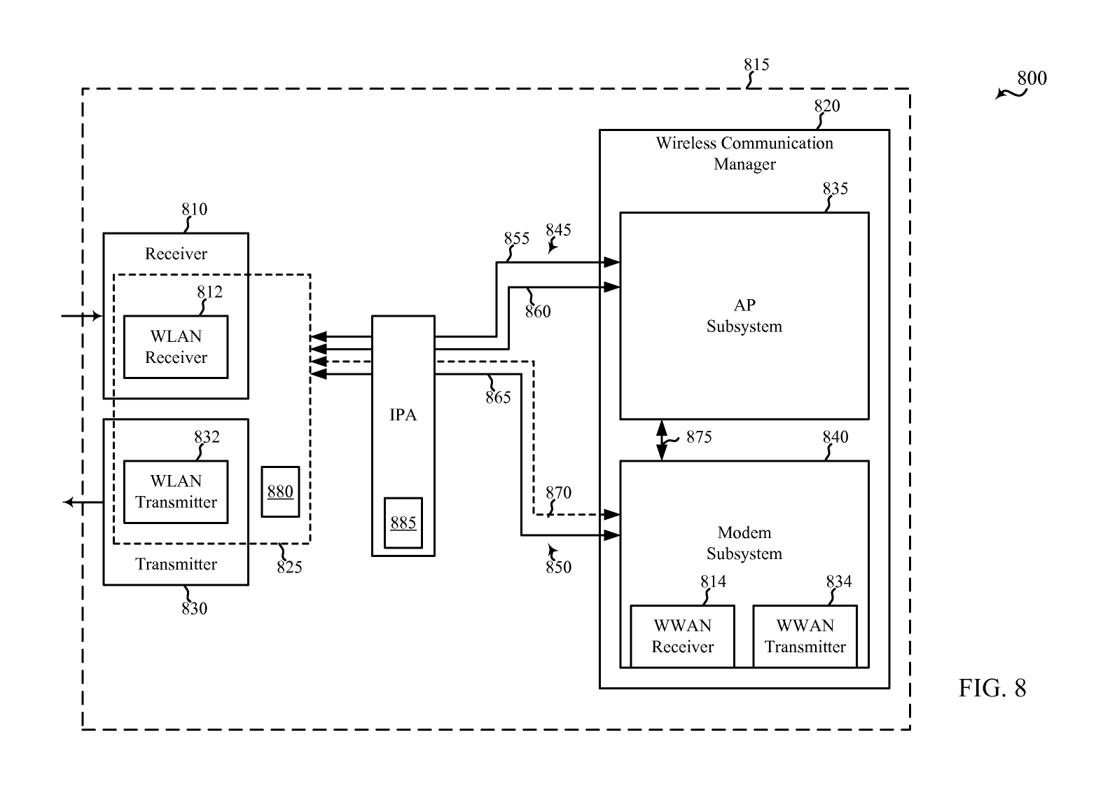

FIG. 8 shows a block diagram 800 of a device 815 for use in wireless communication, in accordance with various aspects of the present disclosure. In some embodiments, the device 815 may be an example of aspects of one of the UEs described with reference to FIG. 1, 2, or 3. The device 815 may also be a processor. In some examples, the device 815 may implement the DWD model 400, 500, 600, or 700 described with reference to FIG. 4, 5, 6, or 7. The device 815 may include a receiver 810, a wireless communication manager 820, and a transmitter 830. Each of these components may be in communication with each other.

The components of the device 815 may, individually or collectively, be implemented using application-specific integrated circuits (ASICs) adapted to perform some or all of the applicable functions in hardware. Alternatively, the functions may be performed by other processing units (or cores), on integrated circuits. In other embodiments, other types of integrated circuits may be used (e.g., Structured/Platform ASICs, Field Programmable Gate Arrays (FPGAs), and other Semi-Custom ICs), which may be programmed in any manner known in the art. The functions of each unit may also be implemented, in whole or in part, with instructions embodied in a memory, formatted to be executed by general or application-specific processors.

In some embodiments, the receiver 810 may be or include a radio frequency (RF) receiver. For example, the receiver 810 may include a WLAN receiver 812 operable to receive transmissions in a frequency spectrum used for WLAN communications. The receiver 810 may also, or alternatively, include another type of RF receiver, such as the WWAN receiver 814 (e.g., an LTE/LTE-A receiver) associated with the modem subsystem 840. The receiver 810 may also, or alternatively, include a receiver for a wired connection (e.g., a wired universal serial bus (USB) connection).

The receiver 810 may be used to receive various types of data or control signals (i.e., transmissions) over communication links of a wireless communication system, such as communication links of the WLAN or WWAN described with reference to FIG. 1, 2, or 3.

In some embodiments, the transmitter 830 may be or include an RF transmitter. For example, the transmitter 830 may include a WLAN transmitter 832 operable to transmit in a frequency spectrum used for WLAN communications. The transmitter 830 may also, or alternatively, include another type of RF transmitter, such as the WWAN transmitter 834 (e.g., an LTE/LTE-A transmitter) associated with the modem subsystem 840. The transmitter 830 may also, or alternatively, include a transmitter to receive transmissions over a wired connection (e.g., a wired USB connection).

The transmitter 830 may be used to transmit various types of data or control signals (i.e., transmissions) over communication links of a wireless communication system, such as communication links of the WLAN or WWAN described with reference to FIG. 1, 2, or 3.

In some examples of the device 815, part or all of the WLAN receiver 812 and the WLAN transmitter 832 may be implemented by a WLAN chipset 825. The WLAN chipset 825 may be an example of the WLAN chipset 405, 505, 605, or 705 described with reference to FIG. 4, 5, 6, or 7.

The wireless communication manager 820 may perform various tasks related to the management of wireless communications at the receiver 810 and the transmitter 830. In some cases, the wireless communication manager 820 may be used to manage WLAN interfaces and WWAN interfaces of the device 815 and may include an AP subsystem 835 and a modem subsystem 840. The wireless communication manager 820 may establish a first WLAN interface 845 between the WLAN chipset 825 and the AP subsystem 835, and a second WLAN interface 850 between the WLAN chipset 825 and the modem subsystem 840. The first WLAN interface 845 and the second WLAN interface 850 may be established with the same WLAN association. The first WLAN interface 845 may include a data interface 855 and a control interface 860. The second WLAN interface 850 may include a data interface 865 that bypasses the AP subsystem 835 (e.g., a direct digital interconnect such as a peripheral component interconnect express (PCIe) interface, which provides a direct data path between the WLAN chipset 825 and the modem subsystem 840). The second WLAN interface 850 may also include a control interface 870. Additionally or alternatively to the control interface 870, a control interface 875 may be provided between the modem subsystem 840 and the AP subsystem 835. The control interface 870 or 875 may enable control of part or all of the first WLAN interface 845 (i.e., the WLAN interface between the WLAN chipset 825 and the AP subsystem 835) by the modem subsystem 840. When the first WLAN interface 845 is controlled by the modem subsystem 840 via the control interface 875, the control may be provided by the modem subsystem 840 via the AP subsystem 835.

In some configurations, the wireless communication manager 820 may install a number of filters 880 in the WLAN chipset 825 or a number of filters 885 in the data path between the modem subsystem 840 and the WLAN chipset 825 (e.g., in an IPA 890 in the data path). The filter(s) 880 or 885 may be used to route data packets received by the WLAN chipset 825 to the AP subsystem 835 or the modem subsystem 840. The routing of data packets may be based on filter matching. In some cases, the nature of the filters may be specified by either or both of the AP subsystem 835 and the modem subsystem 840. When specified by the modem subsystem 840, a filter may be provided to the WLAN chipset 825 (e.g., for installation), by the modem subsystem 840, via the control interface 870. Alternatively, the filter may be provided to the AP subsystem 835, by the modem subsystem 840, via the control interface 875, and then provided to the WLAN chipset 825, by the AP subsystem 835, via the control interface 860.

In use, WLAN traffic may flow through the WLAN chipset 825, to and from the AP subsystem 835 or the modem subsystem 840. When WLAN traffic associated with the AP subsystem 835 does not exist (e.g., is absent), the AP subsystem 835 may be transitioned to a power saving mode.

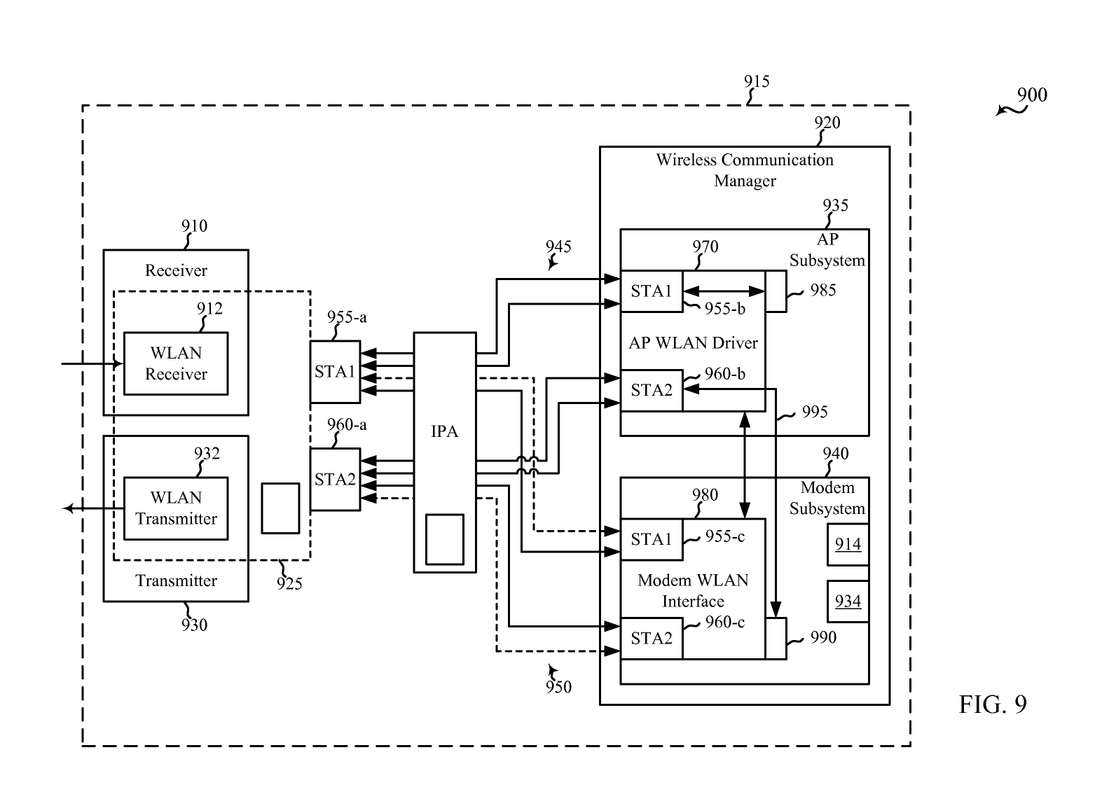

FIG. 9 shows a block diagram 900 of a device 915 for use in wireless communication, in accordance with various aspects of the present disclosure. In some embodiments, the device 915 may be an example of aspects of one of the UEs described with reference to FIG. 1, 2, or 3. The device 915 may also be a processor. In some examples, the device 915 may implement the DWD model 500 or 500-a described with reference to FIG. 5 or 6. The device 915 may include a receiver 910, a wireless communication manager 920, and a transmitter 930. Each of these components may be in communication with each other.

The components of the device 915 may, individually or collectively, be implemented using ASICs adapted to perform some or all of the applicable functions in hardware. Alternatively, the functions may be performed by other processing units (or cores), on integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by general or application-specific processors.

In some embodiments, the receiver 910 may be or include an RF receiver. For example, the receiver 910 may include a WLAN receiver 912 operable to receive transmissions in a frequency spectrum used for WLAN communications. The receiver 910 may also, or alternatively, include another type of RF receiver, such as the WWAN receiver 914 (e.g., an LTE/LTE-A receiver) associated with the modem subsystem 940. The receiver 910 may also, or alternatively, include a receiver for a wired connection (e.g., a wired USB connection).

The receiver 910 may be used to receive various types of data or control signals (i.e., transmissions) over communication links of a wireless communication system, such as communication links of the WLAN or WWAN described with reference to FIG. 1, 2, or 3.

In some embodiments, the transmitter 930 may be or include an RF transmitter. For example, the transmitter 930 may include a WLAN transmitter 932 operable to transmit in a frequency spectrum used for WLAN communications. The transmitter 930 may also, or alternatively, include another type of RF transmitter, such as the WWAN transmitter 934 (e.g., an LTE/LTE-A transmitter) associated with the modem subsystem 940. The transmitter 930 may also, or alternatively, include a transmitter to receive transmissions over a wired connection (e.g., a wired USB connection).

The transmitter 930 may be used to transmit various types of data or control signals (i.e., transmissions) over communication links of a wireless communication system, such as communication links of the WLAN or WWAN described with reference to FIG. 1, 2, or 3.

In some examples of the device 915, part or all of the WLAN receiver 912 and the WLAN transmitter 932 may be implemented by a WLAN chipset 925. The WLAN chipset 925 may be an example of the WLAN chipset 405, 505, 605, or 705 described with reference to FIG. 4, 5, 6, or 7.

The wireless communication manager 920 may perform various tasks related to the management of wireless communications via the receiver 910 and the transmitter 930. In some cases, the wireless communication manager 920 may be used to manage WLAN connections and WWAN connections of the device 915 and may include an AP subsystem 935 and a modem subsystem 940. The wireless communication manager 920 may establish a first WLAN interface 945 between the WLAN chipset 925 and the AP subsystem 935, and a second WLAN interface 950 between the WLAN chipset 925 and the modem subsystem 940. The first WLAN interface 945 and the second WLAN interface 950 may be established with the same WLAN association. The data interfaces and control interfaces of each of the WLAN interfaces 945, 950 may be similar to the data interfaces and control interfaces described with reference to FIG. 8.

The modem subsystem 940 may dynamically manage at least one aspect of the first WLAN interface 945 via a WLAN management interface 995. In some configurations, the WLAN management interface 995 may directly connect the modem subsystem 940 to the AP subsystem 935. In some cases, a supplicant 990 of the modem subsystem 940 may dynamically manage at least one aspect of the first WLAN interface 945 through an AP WLAN driver 970 of the AP subsystem 935.

As shown, the WLAN chipset 925, the AP subsystem 935, and the modem subsystem 940 may implement a first WLAN station 955 and a second WLAN station 960, each of which may be enabled or disabled (e.g., allowed or not allowed to associate with an SSID). By way of example, the first WLAN station 955 may include parts of the WLAN chipset 925 (e.g., the STA1 interface 955-a), parts of the AP subsystem 935 (e.g., the STA1 controller 955-b of the AP WLAN driver 970), and parts of the modem subsystem 940 (e.g., the STA1 controller 955-c of the modem WLAN interface 980). Similarly, the second WLAN station 960 may include parts of the WLAN chipset 925 (e.g., the STA2 interface 960-a), parts of the AP subsystem 935 (e.g., the STA2 controller 960-b of the AP WLAN driver 970), and parts of the modem subsystem 940 (e.g., the STA2 controller 960-c of the modem WLAN interface 980).

When enabled, at least one of the WLAN stations (e.g., the second WLAN station 960) may operate in one of a first mode in which the WLAN station (e.g., the second WLAN station 960) is enabled to associate only with a HLOS SSID, a second mode in which the WLAN station (e.g., the second WLAN station 960) is enabled to associate only with a modem SSID, and a third mode in which the WLAN station (e.g., the second WLAN station 960) is enabled to associate with one of a HLOS SSID and a modem SSID based on a HLOS/modem SSID prioritization. In some cases, the HLOS/modem SSID prioritization may be configured as described with reference to STA2 of Table 1.

In some examples of the device 915, the first WLAN station 955, when enabled, may associate only with a HLOS SSID, and the second WLAN station 960, when enabled, may operate in one of the three modes described above. An association of the first WLAN station 955 with a HLOS SSID may be managed by the supplicant 985 of the AP subsystem 935 (e.g., a connection manager of the HLOS) via the AP WLAN driver 970. An association of the second WLAN station 960 with a HLOS SSID may also be managed by the supplicant 985 of the AP subsystem 935 via the AP WLAN driver 970. However, a modem SSID may be associated with the second WLAN station 960 under control of the modem subsystem 940. In some cases, the supplicant 990 of the modem subsystem 940 may control the association via the WLAN management interface 995 and the AP WLAN driver 970.

In some examples, dynamic management of the first WLAN interface 945, using the modem subsystem 940, may include the modem subsystem 940 (and more particularly, the supplicant 990 of the modem subsystem 940) dynamically managing, through the AP WLAN driver 970 of the AP subsystem 935, aspects of the second WLAN station 960. Such a dynamic management of the second WLAN station 960 may be employed, for example, when a WLAN connection over the first WLAN interface 945 uses the second WLAN station 960 and the second WLAN station 960 is associated with a modem SSID. When the modem subsystem 940 dynamically manages the first WLAN interface 945 in this manner, the WLAN connection that uses the second WLAN station 960 may be hidden from the HLOS. Furthermore, the HLOS may relinquish management of the second WLAN station 960 to the modem subsystem 940 for a period of time. When the association of the second WLAN station 960 with the modem SSID terminates, management of the second WLAN station 960 may be relinquished by the modem subsystem 940.

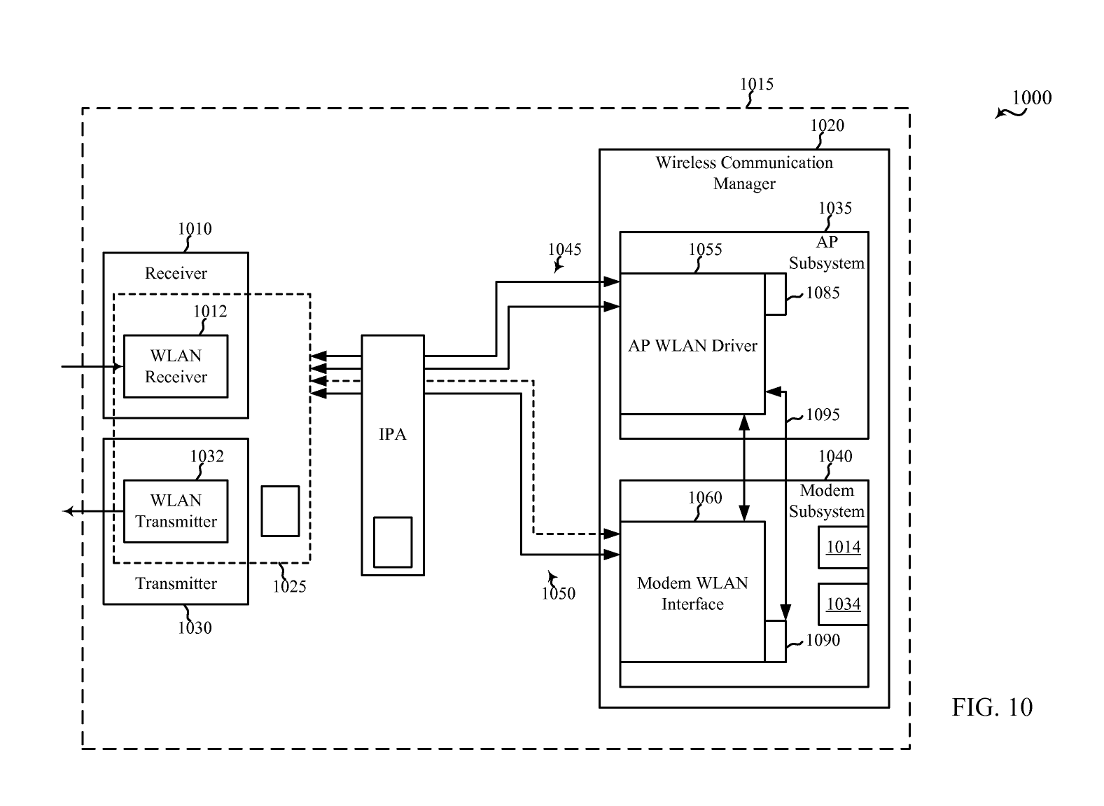

FIG. 10 shows a block diagram 1000 of a device 1015 for use in wireless communication, in accordance with various aspects of the present disclosure. In some embodiments, the device 1015 may be an example of aspects of one of the UEs described with reference to FIG. 1, 2, or 3. The device 1015 may also be a processor. In some examples, the device 1015 may implement the DWD model 700 described with reference to FIG. 7. The device 1015 may include a receiver 1010, a wireless communication manager 1020, and a transmitter 1030. Each of these components may be in communication with each other.

The components of the device 1015 may, individually or collectively, be implemented using ASICs adapted to perform some or all of the applicable functions in hardware. Alternatively, the functions may be performed by other processing units (or cores), on integrated circuits. In other embodiments, other types of integrated circuits may be used (e.g., Structured/Platform ASICs, FPGAs, and other Semi-Custom ICs), which may be programmed in any manner known in the art. The functions of each unit may also be implemented, in whole or in part, with instructions embodied in a memory, formatted to be executed by general or application-specific processors.

In some embodiments, the receiver 1010 may be or include an RF receiver. For example, the receiver 1010 may include a WLAN receiver 1012 operable to receive transmissions in a frequency spectrum used for WLAN communications. The receiver 1010 may also, or alternatively, include another type of RF receiver, such as the WWAN receiver 1014 (e.g., an LTE/LTE-A receiver) associated with the modem subsystem 1040. The receiver 1010 may also, or alternatively, include a receiver for a wired connection (e.g., a wired USB connection).

The receiver 1010 may be used to receive various types of data or control signals (i.e., transmissions) over communication links of a wireless communication system, such as communication links of the WLAN or WWAN described with reference to FIG. 1, 2, or 3.

In some embodiments, the transmitter 1030 may be or include an RF transmitter. For example, the transmitter 1030 may include a WLAN transmitter 1032 operable to transmit in a frequency spectrum used for WLAN communications. The transmitter 1030 may also, or alternatively, include another type of RF transmitter, such as the WWAN transmitter 1034 (e.g., an LTE/LTE-A transmitter) associated with the modem subsystem 1040. The transmitter 1030 may also, or alternatively, include a transmitter to receive transmissions over a wired connection (e.g., a wired USB connection).

The transmitter 1030 may be used to transmit various types of data or control signals (i.e., transmissions) over communication links of a wireless communication system, such as communication links of the WLAN or WWAN described with reference to FIG. 1, 2, or 3.

In some examples of the device 1015, part or all of the WLAN receiver 1012 and the WLAN transmitter 1032 may be implemented by a WLAN chipset 1025. The WLAN chipset 1025 may be an example of the WLAN chipset 405, 505, 605, or 705 described with reference to FIG. 4, 5, 6, or 7.

The wireless communication manager 1020 may perform various tasks related to the management of wireless communications via the receiver 1010 and the transmitter 1030. In some cases, the wireless communication manager 1020 may be used to manage WLAN connections and WWAN connections of the device 1015 and may include an AP subsystem 1035 and a modem subsystem 1040. The wireless communication manager 1020 may establish a first WLAN interface 1045 between the WLAN chipset 1025 and the AP subsystem 1035, and a second WLAN interface 1050 between the WLAN chipset 1025 and the modem subsystem 1040. The first WLAN interface 1045 and the second WLAN interface 1050 may be established with the same WLAN association. The data interfaces and control interfaces of each of the WLAN interfaces 1045, 1050 may be similar to the data interfaces and control interfaces described with reference to FIG. 8 or 9.

The modem subsystem 1040 may dynamically manage aspects of the first WLAN interface 1045 via a WLAN management interface 1095. In some configurations, the WLAN management interface 1095 may directly connect the modem subsystem 1040 to the AP subsystem 1035. In some cases, a supplicant 1090 of the modem subsystem may dynamically manage aspects of the first WLAN interface 1045 through an AP WLAN driver 1055 of the AP subsystem 1035.

The WLAN chipset 1025, the AP subsystem 1035, and the modem subsystem 1040 may implement a WLAN station. By way of example, the first WLAN station may include parts of the WLAN chipset 1025 (e.g., a station interface), parts of the AP subsystem 1035 (e.g., a first station controller of the AP WLAN driver 1055), and parts of the modem subsystem 1040 (e.g., a second station controller of the modem WLAN interface 1060).

The WLAN station may operate in one of a first mode in which the WLAN station is enabled to associate only with a HLOS SSID, a second mode in which the WLAN station is enabled to associate only with a modem SSID, and a third mode in which the WLAN station is enabled to associate with one of a HLOS SSID and a modem SSID based at least in part on a HLOS/modem SSID prioritization. In some cases, the HLOS/modem SSID prioritization may be configured as described with reference to STA2 of Table 1.

In some examples, the WLAN station may operate in the third mode and a modem SSID may be transferred from the modem subsystem 1040 to the AP WLAN driver 1055. The modem SSID may then be prioritized (e.g., by the AP WLAN driver 1055) with respect to a HLOS SSID. Thereafter, the WLAN station may be associated with a modem SSID or a HLOS SSID based on the prioritizing.

An association of the WLAN station with a HLOS SSID may be managed by a supplicant 1085 of the AP subsystem 1035 via the AP WLAN driver 1055. However, a modem SSID may be associated with the WLAN station under control of the modem subsystem 1040. In some cases, the supplicant 1090 of the modem subsystem 1040 may control the association via the WLAN management interface 1095 and the AP WLAN driver 1055.

In some examples, dynamic management of the first WLAN interface 1045, using the modem subsystem 1040, may include the modem subsystem 1040 (and more particularly, the supplicant 1090 of the modem subsystem 1040) dynamically managing, through the AP WLAN driver 1055 of the AP subsystem 1035, aspects of the WLAN station. Such a dynamic management of the second WLAN station may be employed, for example, when a WLAN connection over the first WLAN interface 1045 uses the WLAN station and the WLAN station is associated with a modem SSID. When the modem subsystem 1040 dynamically manages the first WLAN interface 1045 in this manner, the WLAN connection that uses the WLAN station may be hidden from the HLOS. Furthermore, the HLOS may relinquish management of the WLAN station to the modem subsystem 1040 for a period of time. When the association of the WLAN station with the modem SSID terminates, management of the WLAN connection on the WLAN station may be relinquished by the modem subsystem 1040.

In some embodiments, aspects of two or more of the devices 815, 915, and 1015 may be combined.

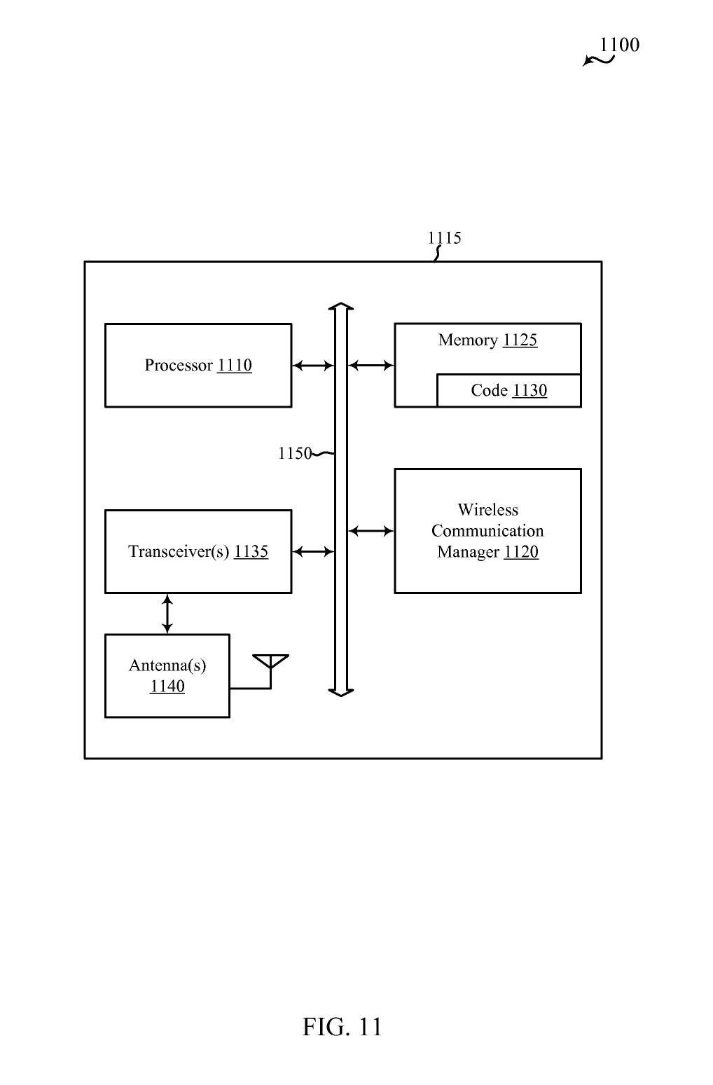

FIG. 11 shows a block diagram 1100 of a device 1115 (e.g., a UE) for wireless communication, in accordance with various aspects of the present disclosure. The device 1115 may have various configurations and may be or be part of a computer (e.g., a laptop computer, netbook computer, tablet computer, etc.), a cellular telephone, a personal digital assistant (PDA), a digital video recorder (DVR), an internet appliance, a gaming console, an e-reader, etc. The device 1115 may in some cases have an internal power supply (not shown), such as a small battery, to facilitate mobile operation. In some embodiments, the device 1115 may be an example of aspects of the UEs described with reference to FIG. 1, 2, or 3, or aspects of the device 815, 915, or 1015 described with reference to FIG. 8, 9, or 10. The device 1115 may implement at least some of the features and functions described with reference to FIGS. 1-10. The device 1115 may communicate with access points (e.g., WLAN access points or WWAN access points (e.g., eNBs or base stations) such as the access points described with reference to FIG. 1, 2, or 3.

The device 1115 may include a processor 1110, a memory 1125 (including code 1130), at least one transceiver (represented by transceiver(s) 1135), at least one antenna (represented by antenna(s) 1140), or a wireless communication manager 1120. Each of these components may be in communication with each other, directly or indirectly, over at least one bus 1150.

The transceiver(s) 1135, in conjunction with the antenna(s) 1140, may facilitate wireless communication with access points or other devices. Wireless communication with an access point may be managed using the wireless communication manager 1120.

The processor 1110 may include an intelligent hardware device, e.g., a central processing unit (CPU), a microcontroller, an ASIC, etc. The processor 1110 may process information received through the transceiver(s) 1135 or process information to be sent to the transceiver(s) 1135 for transmission through the antenna(s) 1140. The processor 1110 may handle, alone or in connection with the wireless communication manager 1120, various aspects of communicating over a wireless or wired communication system.

The memory 1125 may include random access memory (RAM) or read-only memory (ROM). The memory 1125 may store computer-readable, computer-executable code 1130 (e.g., firmware or software) containing instructions that may, when executed, cause the processor 1110 to perform various functions described herein for communicating over a wireless communication system. Alternatively, the code 1130 may not be directly executable by the processor 1110 but may cause the device 1115 (e.g., when compiled and executed) to perform various of the functions described herein.

The wireless communication manager 1120 may be an example of aspects of the wireless communication manager 820, 920, or 1020 described with reference to FIG. 8, 9, or 10. The wireless communication manager 1120 may be used to manage the wireless connection(s) of the device 1115 to WLAN access points or WWAN access points.

In some embodiments, the wireless communication manager 1120, or portions of the wireless communication manager 1120, may include a processor, or some or all of the functionality of the wireless communication manager 1120 may be performed by the processor 1110 or in connection with the processor 1110.

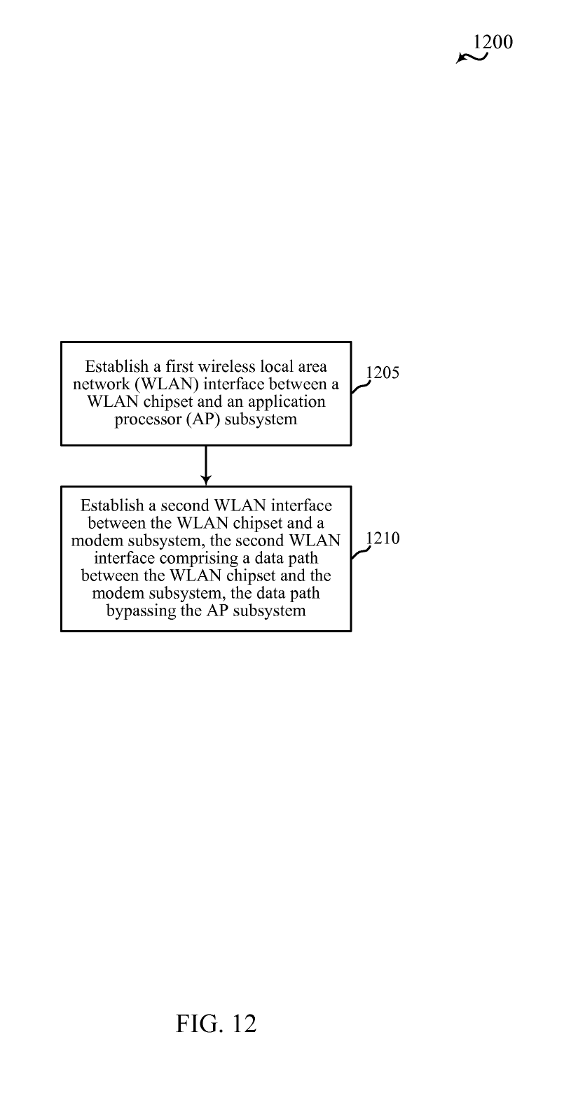

FIG. 12 is a flow chart illustrating an example of a method 1200 for wireless communication, in accordance with various aspects of the present disclosure. For clarity, the method 1200 is described below with reference to aspects of the device 815, 915, 1015, or 1115 described with reference to FIG. 8, 9, 10, or 11. In some embodiments, a device such as one of the devices 815, 915, 1015, or 1115 may execute sets of codes to control the functional elements of the device to perform the functions described below.

At block 1205, a first WLAN interface may be established between a WLAN chipset and an AP subsystem. The operation(s) at block 1205 may in some cases be performed using the wireless communication manager 820, 920, 1020, or 1120 described with reference to FIG. 8, 9, 10, or 11. In some examples, the WLAN chipset may be the WLAN chipset 405, 505, 605, 705, 825, 925, or 1025 described with reference to FIG. 4, 5, 6, 7, 8, 9, or 10, or the AP subsystem may be the AP subsystem 410, 510, 610, 710, 835, 935, or 1035 described with reference to FIG. 4, 5, 6, 7, 8, 9, or 10.

At block 1210, a second WLAN interface may be established between the WLAN chipset and a modem subsystem. The first WLAN interface and the second WLAN interface may be established with the same WLAN association. The second WLAN interface may include a data path between the WLAN chipset and the modem subsystem. The data path may bypass the AP subsystem. The operation(s) at block 1210 may in some cases be performed using the wireless communication manager 820, 920, 1020, or 1120 described with reference to FIG. 8, 9, 10, or 11. In some examples, the modem subsystem may be the modem subsystem 420, 520, 620, 720, 840, 940, or 1040 described with reference to FIG. 4, 5, 6, 7, 8, 9, or 10. In some examples, the data path between the WLAN chipset and the modem subsystem may include a direct digital interconnect. In some cases, the direct digital interconnect may implement a PCIe interface.

In some embodiments, the method 1200 may include transitioning the AP subsystem to a power saving mode when WLAN traffic associated with the AP subsystem is absent.

In some configurations, the method 1200 may include routing data packets received by the WLAN chipset to the AP subsystem or the modem subsystem. The data packets may be routed, in some cases, using a filter (e.g., by performing filter matching). The filter may be specified by the AP subsystem, the modem subsystem, or both. When a filter is provided by the modem subsystem, the filter may be provided to the WLAN chipset via a control interface connecting the WLAN chipset and the modem subsystem. Alternatively, the modem subsystem may provide a filter to the AP subsystem, and the AP subsystem may provide the filter to the WLAN chipset. By way of example, a filter specified by the AP subsystem or the modem subsystem may be installed in the WLAN chipset or in the data path between the WLAN chipset and the modem subsystem (e.g., in an IPA in the data path).

Thus, the method 1200 may provide for wireless communication. The method 1200 is just one implementation and the operations of the method 1200 may be rearranged or otherwise modified such that other implementations are possible.

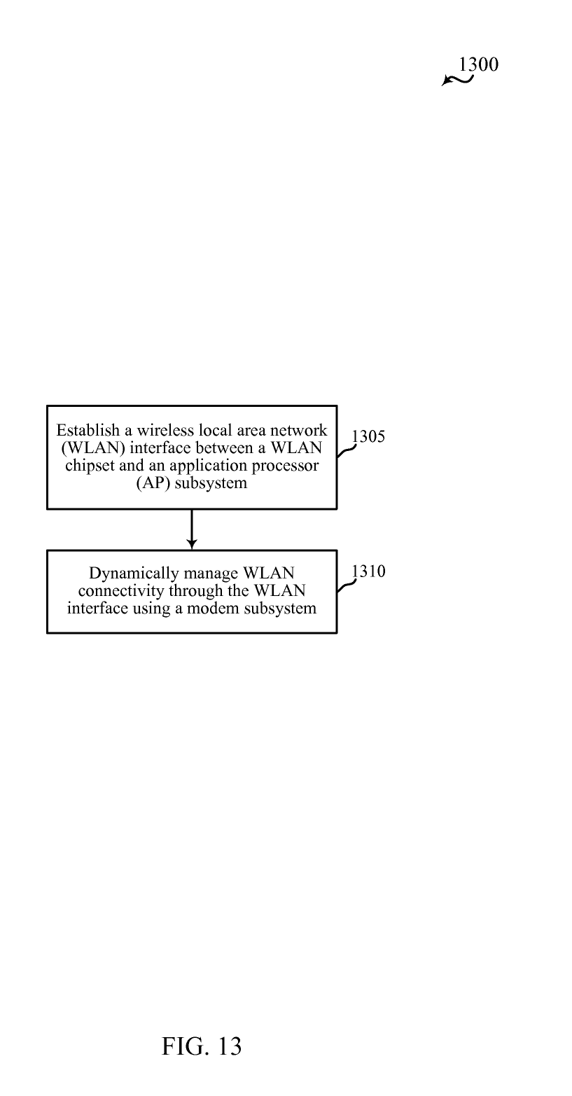

FIG. 13 is a flow chart illustrating an example of a method 1300 for wireless communication, in accordance with various aspects of the present disclosure. For clarity, the method 1300 is described below with reference to aspects of the device 915, 1015, or 1115 described with reference to FIG. 9, 10, or 11. In some embodiments, a device such as one of the devices 915, 1015, or 1115 may execute sets of codes to control the functional elements of the device to perform the functions described below.

At block 1305, a WLAN interface may be established between a WLAN chipset and an AP subsystem. The operation(s) at block 1305 may in some cases be performed using the wireless communication manager 920, 1020, or 1120 described with reference to FIG. 9, 10, or 11. In some examples, the WLAN chipset may be the WLAN chipset 505, 605, 705, 925, or 1025 described with reference to FIG. 5, 6, 7, 9, or 10, or the AP subsystem may be the AP subsystem 510, 610, 710, 935, or 1035 described with reference to FIG. 5, 6, 7, 9, or 10.

At block 1310, WLAN connectivity through the WLAN interface may be dynamically managed using a modem subsystem. The operation(s) at block 1310 may in some cases be performed using the modem subsystem 520, 620, 720, 940, or 1040 described with reference to FIG. 5, 6, 7, 9, or 10.

Thus, the method 1300 may provide for wireless communication. The method 1300 is just one implementation and the operations of the method 1300 may be rearranged or otherwise modified such that other implementations are possible.

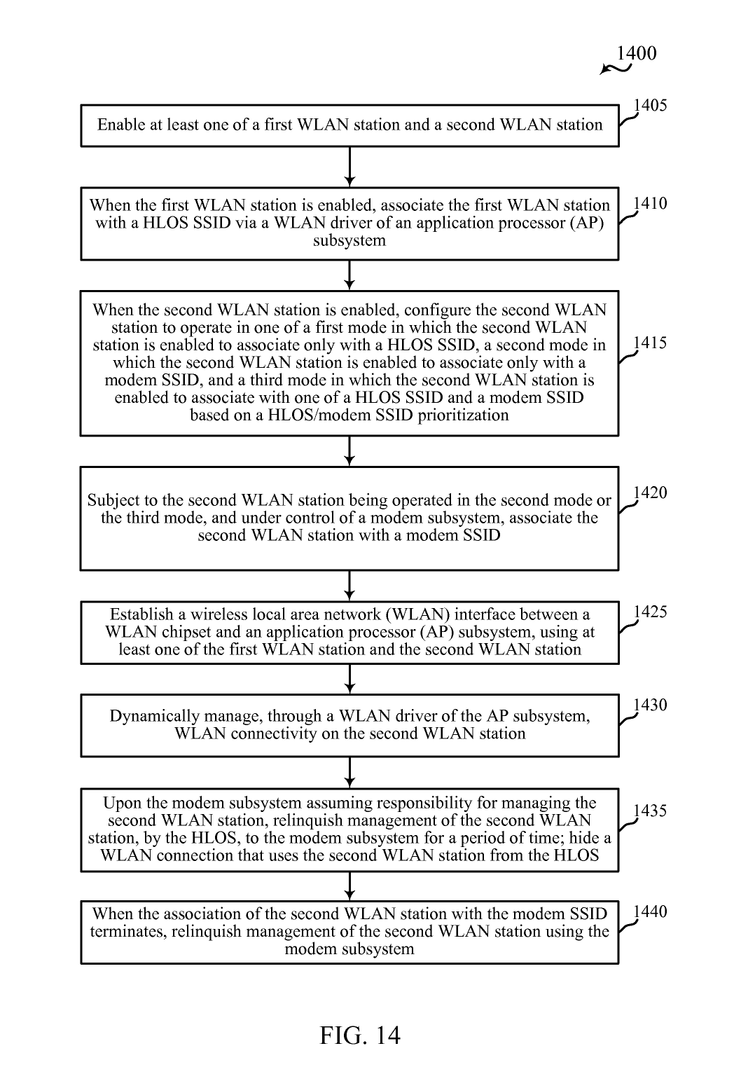

FIG. 14 is a flow chart illustrating an example of a method 1400 for wireless communication, in accordance with various aspects of the present disclosure. For clarity, the method 1400 is described below with reference to aspects of the device 915 or 1115 described with reference to FIG. 9 or 11. In some embodiments, a device such as one of the devices 915 or 1115 may execute sets of codes to control the functional elements of the device to perform the functions described below.

At block 1405, at least one of a first WLAN station and a second WLAN station may be enabled. Each of the WLAN stations may be embodied in parts of the WLAN chipset, the AP subsystem, and a modem subsystem. The operation(s) at block 1405 may in some cases be performed using the wireless communication manager 920 or 1120 described with reference to FIG. 9 or 11. In some examples, the WLAN chipset may be the WLAN chipset 505 or 925 described with reference to FIG. 5 or 9, or the AP subsystem may be the AP subsystem 510 or 935 described with reference to FIG. 5 or 9. In some examples, the modem subsystem may be the modem subsystem 520 or 940 described with reference to FIG. 5 or 9.

At block 1410, and when the first WLAN station is enabled, the first WLAN station may in some cases be associated with a HLOS SSID via a AP WLAN driver of the AP subsystem. The operation(s) at block 1410 may in some cases be performed using the wireless communication manager 920 or 1120 described with reference to FIG. 9 or 11, or the AP subsystem 510 or 935 described with reference to FIG. 5 or 9, or the AP WLAN driver 515 or 970 described with reference to FIG. 5 or 9.

At block 1415, and when the second WLAN station is enabled, the second WLAN station may operate in one of a first mode in which the second WLAN station is enabled to associate only with a HLOS SSID, a second mode in which the second WLAN station is enabled to associate only with a modem SSID, and a third mode in which the second WLAN station is enabled to associate with one of a HLOS SSID and a modem SSID based on a HLOS/modem SSID prioritization. The operation(s) at block 1415 may in some cases be performed using the wireless communication manager 920 or 1120 described with reference to FIG. 9 or 11, or the AP subsystem 510 or 935 described with reference to FIG. 5 or 9, or the modem subsystem 520 or 940 described with reference to FIG. 5 or 9.

At block 1420, and subject to the second WLAN station being operated in the second mode or the third mode, the second WLAN station may in some cases be associated with a modem SSID. The association may be made under control of a modem subsystem, such as the modem subsystem 520 or 940 described with reference to FIG. 5 or 9.

At block 1425, a WLAN interface may be established between the WLAN chipset and the AP subsystem using at least one of the first WLAN station or the second WLAN station. The operation(s) at block 1425 may in some cases be performed using the wireless communication manager 920 or 1120 described with reference to FIG. 9 or 11.

At block 1430, WLAN connectivity through the WLAN interface may be dynamically managed using the modem subsystem. More particularly, and in one example, the modem subsystem may dynamically manage WLAN connectivity on the second WLAN station. The modem subsystem may dynamically manage the second WLAN station through the AP WLAN driver of the AP subsystem. The operation(s) at block 1430 may in some cases be performed using the modem subsystem 520 or 940 described with reference to FIG. 5 or 9.

Upon the modem subsystem assuming responsibility for managing the second WLAN station, and at block 1435, the HLOS may relinquish management of the second WLAN station to the modem subsystem for a period of time, or a WLAN connection that uses the second WLAN station may be hidden from the HLOS. The relinquishment may in some cases be performed using the AP subsystem 510 or 935 described with reference to FIG. 5 or 9, or the supplicant 985 described with reference to FIG. 9. The hiding may in some cases be performed using the AP subsystem 510 or 935 described with reference to FIG. 5 or 9, or the AP WLAN driver 515 or 970 described with reference to FIG. 5 or 9.

When the association of the second WLAN station with the modem SSID terminates, and at block 1440, management of the second WLAN station using the modem subsystem may be relinquished. The relinquishment may in some cases be performed using the modem subsystem 520 or 940 described with reference to FIG. 5 or 9.

Thus, the method 1400 may provide for wireless communication. The method 1400 is just one implementation and the operations of the method 1400 may be rearranged or otherwise modified such that other implementations are possible.

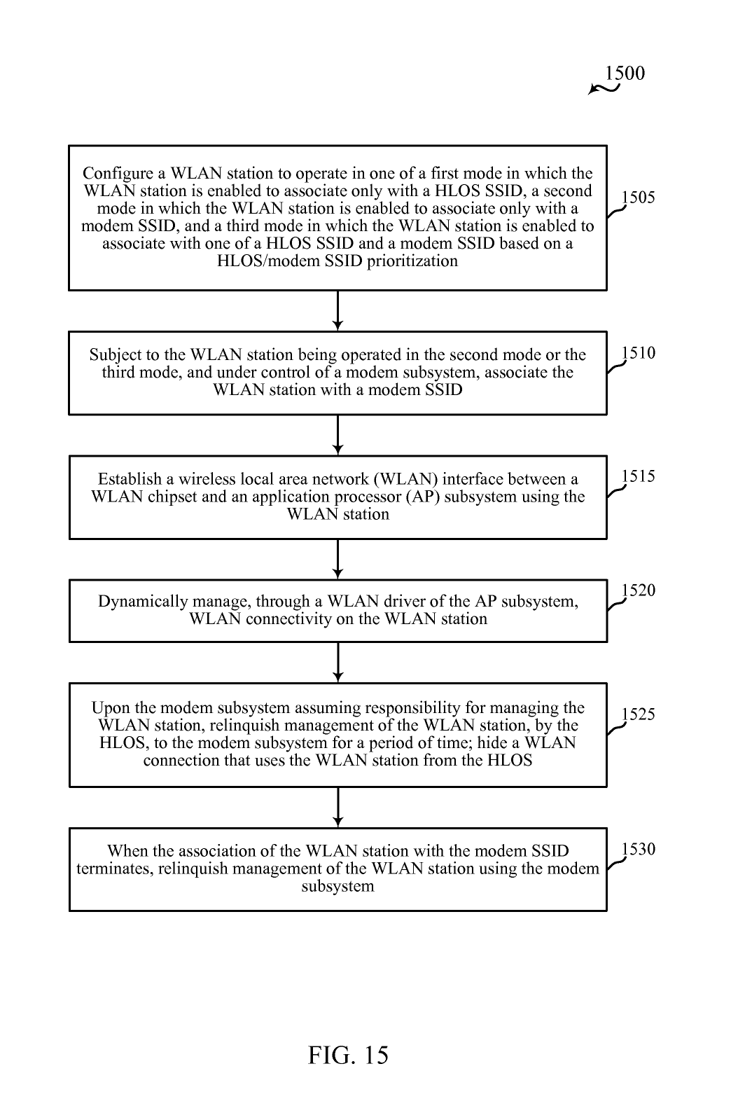

FIG. 15 is a flow chart illustrating an example of a method 1500 for wireless communication, in accordance with various aspects of the present disclosure. For clarity, the method 1500 is described below with reference to aspects of the device 1015 or 1115 described with reference to FIG. 10 or 11. In some embodiments, a device such as one of the devices 1015 or 1115 may execute sets of codes to control the functional elements of the device to perform the functions described below.

At block 1505, the WLAN station may operate in one of a first mode in which the WLAN station is enabled to associate only with a HLOS SSID, a second mode in which the WLAN station is enabled to associate only with a modem SSID, and a third mode in which the WLAN station is enabled to associate with one of a HLOS SSID and a modem SSID based on a HLOS/modem SSID prioritization. The operation(s) at block 1505 may in some cases be performed using the wireless communication manager 1020 or 1120 described with reference to FIG. 10 or 11, or the AP subsystem 610, 710, or 1035 described with reference to FIG. 6, 7, or 10, or the modem subsystem 620, 720, or 1040 described with reference to FIG. 6, 7, or 10. In some examples, the WLAN chipset may be the WLAN chipset 605, 705, or 1025 described with reference to FIG. 6, 7, or 10, or the AP subsystem may be the AP subsystem 610, 710, or 1035 described with reference to FIG. 6, 7, or 10.

At block 1510, and subject to the WLAN station being operated in the second mode or the third mode, the WLAN station may in some cases be associated with a modem SSID. The association may be made under control of a modem subsystem, such as the modem subsystem 620, 720, or 1040 described with reference to FIG. 6, 7, or 10.

At block 1515, a WLAN interface may be established between a WLAN chipset and an AP subsystem using the WLAN station. The operation(s) at block 1515 may in some cases be performed using the wireless communication manager 1020 or 1120 described with reference to FIG. 10 or 11.

At block 1520, WLAN connectivity through the WLAN interface may be dynamically managed using the modem subsystem. More particularly, and in one example, the modem subsystem may dynamically manage WLAN connectivity on the WLAN station. The modem subsystem may dynamically manage the WLAN station through the AP WLAN driver of the AP subsystem. The operation(s) at block 1520 may in some cases be performed using the modem subsystem 620, 720, or 1040 described with reference to FIG. 6, 7, or 10.

Upon the modem subsystem assuming responsibility for managing the WLAN station, and at block 1525, the HLOS may relinquish management of the WLAN station to the modem subsystem for a period of time, or the WLAN connection that uses the WLAN station may be hidden from the HLOS. The relinquishment may in some cases be performed using the AP subsystem 610, 710, or 1035 described with reference to FIG. 6, 7, or 10, or the supplicant 1085 described with reference to FIG. 10. The hiding may in some cases be performed using the AP subsystem 610, 710, or 1035 described with reference to FIG. 6, 7, or 10, or the AP WLAN driver 615, 715, or 1055 described with reference to FIG. 6, 7, or 10.

When the association of the WLAN station with the modem SSID terminates, and at block 1530, management of the WLAN station using the modem subsystem may be relinquished. The relinquishment may in some cases be performed using the modem subsystem 620, 720, or 1040 described with reference to FIG. 6, 7, or 10.

Thus, the method 1500 may provide for wireless communication. The method 1500 is just one implementation and the operations of the method 1500 may be rearranged or otherwise modified such that other implementations are possible.

In some embodiments, aspects of two or more of the methods 1200, 1300, 1400, and 1500 may be combined.

The detailed description set forth above in connection with the appended drawings describes exemplary embodiments and does not represent the only embodiments that may be implemented or that are within the scope of the claims. The term “exemplary” used throughout this description means “serving as an example, instance, or illustration,” and not “preferred” or “advantageous over other embodiments.” The detailed description includes specific details for the purpose of providing an understanding of the described techniques. These techniques, however, may be practiced without these specific details. In some instances, well-known structures and devices are shown in block diagram form in order to avoid obscuring the concepts of the described embodiments.

Information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, multiple microprocessors, microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations. Also, as used herein, including in the claims, “or” as used in a list of items (for example, a list of items prefaced by a phrase such as “at least one of” or “one or more of”) indicates a disjunctive list such that, for example, a list of “at least one of A, B, or C” means A or B or C or AB or AC or BC or ABC (i.e., A and B and C).

Computer-readable media includes both computer storage media and communication media including any medium that facilitates transfer of a computer program from one place to another. A storage medium may be any available medium that can be accessed by a general purpose or special purpose computer. By way of example, and not limitation, computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and Blu-ray disc where disks usually reproduce data magnetically, while discs reproduce data optically with lasers. Combinations of the above are also included within the scope of computer-readable media.

The previous description of the disclosure is provided to enable a person skilled in the art to make or use the disclosure. Various modifications to the disclosure will be readily apparent to those skilled in the art, and the generic principles defined herein may be applied to other variations without departing from the scope of the disclosure. Throughout this disclosure the term “example” or “exemplary” indicates an example or instance and does not imply or require any preference for the noted example. Thus, the disclosure is not to be limited to the examples and designs described herein but is to be accorded the broadest scope consistent with the principles and novel features disclosed herein.

What is claimed is:

1. A method of wireless communication, comprising:
establishing a wireless local area network (WLAN) interface between a WLAN chipset and an application processor subsystem; and
dynamically managing WLAN connectivity through the WLAN interface using a modem subsystem.

2. The method of claim 1, further comprising:
establishing the WLAN interface using a WLAN station.

3. The method of claim 2, further comprising:
configuring the WLAN station to operate in one of a first mode in which the WLAN station is enabled to associate only with a high level operating system (HLOS) service set identifier (SSID), a second mode in which the WLAN station is enabled to associate only with a modem SSID, and a third mode in which the WLAN station is enabled to associate with one of a HLOS SSID and a modem SSID based at least in part on a HLOS/modem SSID prioritization.

4. The method of claim 3, further comprising:
transferring at least one modem SSID from the modem subsystem to a WLAN driver of the application processor subsystem;
configuring the WLAN station to operate in the third mode; and
prioritizing the at least one modem SSID with respect to at least one HLOS SSID; and
associating the WLAN station with a modem SSID or a HLOS SSID based at least in part on the prioritizing.

5. The method of claim 3, further comprising:
associating the WLAN station with a modem SSID;
wherein dynamically managing the WLAN connectivity through the WLAN interface using the modem subsystem comprises the modem subsystem dynamically managing, through a WLAN driver of the application processor subsystem, WLAN connectivity on the WLAN station.

6. The method of claim 5, further comprising the WLAN driver of the application processor subsystem hiding a WLAN connection that uses the WLAN station from the HLOS.

7. The method of claim 5, further comprising the HLOS relinquishing management of the WLAN station to the modem subsystem for a period of time.

8. The method of claim 5, further comprising:
relinquishing management of the WLAN connectivity on the WLAN station when the association of the WLAN station with the modem SSID terminates.

9. The method of claim 1, further comprising:
establishing the WLAN interface using at least one of a first WLAN station and a second WLAN station.

10. The method of claim 9, further comprising:
enabling at least one of the first WLAN station and the second WLAN station.

11. The method of claim 9, further comprising:
associating, via a WLAN driver of the application processor subsystem, the first WLAN station with a high level operating system (HLOS) service set identifier (SSID).

12. The method of claim 11, further comprising:
configuring the second WLAN station to operate in one of a first mode in which the second WLAN station is enabled to associate only with a HLOS SSID, a second mode in which the second WLAN station is enabled to associate only with a modem SSID, and a third mode in which the second WLAN station is enabled to associate with one of a HLOS SSID and a modem SSID based at least in part on a HLOS/modem SSID prioritization.

13. The method of claim 12, further comprising:
associating, under control of the modem subsystem, the second WLAN station with a modem SSID;
wherein dynamically managing the WLAN connectivity through the WLAN interface using the modem subsystem comprises the modem subsystem dynamically managing, through the WLAN driver of the application processor subsystem, WLAN connectivity on the second WLAN station.

14. The method of claim 13, further comprising the WLAN driver of the application processor subsystem hiding a WLAN connection that uses the second WLAN station from the HLOS.

15. The method of claim 13, further comprising the HLOS relinquishing management of the second WLAN station to the modem subsystem for a period of time.

16. The method of claim 13, further comprising:
relinquishing management of the WLAN connectivity on the second WLAN station, using the modem subsystem, when the association of the second WLAN station with the modem SSID terminates.

17. A device for wireless communication, comprising:
a wireless local area network (WLAN) chipset;
an application processor subsystem;
a wireless communication manager to establish a WLAN interface between the WLAN chipset and the application processor subsystem; and
a modem subsystem to dynamically manage WLAN connectivity through the WLAN interface.

18. The device of claim 17, further comprising:
a WLAN station;
wherein the application processor subsystem establishes the WLAN interface using the WLAN station.

19. The device of claim 18, wherein the WLAN station operates in one of a first mode in which the WLAN station is enabled to associate only with a high level operating system (HLOS) service set identifier (SSID), a second mode in which the WLAN station is enabled to associate only with a modem SSID, and a third mode in which the WLAN station is enabled to associate with one of a HLOS SSID and a modem SSID based at least in part on a HLOS/modem SSID prioritization.

20. The device of claim 19, wherein:
the application processor subsystem comprises a WLAN driver; and
the modem subsystem associates the WLAN station with a modem SSID and dynamically manages, through the WLAN driver, WLAN connectivity on the WLAN station.

21. The device of claim 17, further comprising:
a first WLAN station; and
a second WLAN station;
wherein the application processor subsystem establishes the WLAN interface using at least one of the first WLAN station and the second WLAN station.

22. The device of claim 21, wherein the wireless communication manager enables at least one of the first WLAN station and the second WLAN station.

23. The device of claim 21, wherein:
the application processor subsystem comprises a WLAN driver; and
the application processor subsystem associates, via the WLAN driver, the first WLAN station with a high level operating system (HLOS) service set identifier (SSID).

24. The device of claim 23, wherein the second WLAN station operates in one of a first mode in which the second WLAN station is enabled to associate only with a HLOS SSID, a second mode in which the second WLAN station is enabled to associate only with a modem SSID, and a third mode in which the second WLAN station is enabled to associate with one of a HLOS SSID and a modem SSID based at least in part on a HLOS/modem SSID prioritization.

25. The device of claim 24, wherein the modem subsystem associates the second WLAN station with a modem SSID and dynamically manages, through the WLAN driver, WLAN connectivity on the second WLAN station.

26. A device for wireless communication, comprising:
means for establishing a wireless local area network (WLAN) interface between a WLAN chipset and an application processor subsystem; and
means for dynamically managing WLAN connectivity through the WLAN interface using a modem subsystem.

27. The device of claim 26, further comprising:
means for establishing the WLAN interface using a WLAN station.

28. The device of claim 27, further comprising:
means for configuring the WLAN station to operate in one of a first mode in which the WLAN station is enabled to associate only with a high level operating system (HLOS) service set identifier (SSID), a second mode in which the WLAN station is enabled to associate only with a modem SSID, and a third mode in which the WLAN station is enabled to associate with one of a HLOS SSID and a modem SSID based at least in part on a HLOS/modem SSID prioritization.

29. The device of claim 28, further comprising:
means for associating the WLAN station with a modem SSID;
wherein the means for dynamically managing the WLAN connectivity through the WLAN interface using the modem subsystem comprises means for dynamically managing, through a WLAN driver of the application processor subsystem, WLAN connectivity on the WLAN station.

30. A non-transitory computer-readable medium storing computer-executable code for wireless communication, the code executable by a processor to:
establish a wireless local area network (WLAN) interface between a WLAN chipset and an application processor subsystem; and
dynamically manage WLAN connectivity through the WLAN interface using a modem subsystem.
